(19) United States
(12) Patent Application Publication
(10) Pub. No.: US 2024/0284385 A1
(43) Pub. Date: Aug. 22, 2024

(54) PARENT AND CHILD POSITIONING REFERENCE SIGNAL RESOURCE SET CONFIGURATIONS

(71) Applicant: QUALCOMM Incorporated, San Diego, CA (US)

(72) Inventors: Alexandros MANOLAKOS, Escondido, CA (US); Mukesh KUMAR, Hyderabad (IN); Srinivas YERRAMALLI, San Diego, CA (US)

(21) Appl. No.: 18/569,953

(22) PCT Filed: Jun. 2, 2022
(86) PCT No.: PCT/US2022/072733

§ 371 Date: Dec. 13, 2023

(30) Foreign Application Priority Data
Jul. 28, 2021 (GR) 20210100512

(51) Int. Cl. H04W 64/00; G01S 5/00; G01S 5/02; H04L 5/00

(52) U.S. Cl. CPC H04W 64/00; G01S 5/0036; G01S 5/0226; G01S 5/0236; H04L 5/0051

(57) ABSTRACT

Disclosed are techniques for wireless communication. In an aspect, a UE receives, from a position estimation entity, a parent PRS resource set configuration associated with a set of parent beams from a TRP, and a set of child PRS resource set configurations associated with a respective set of child beams for each of the set of parent beams. The UE performs measurements on the set of parent beams and at least one activated set of child beams. The position estimation entity receives at least one measurement report(s) based on measurements associated with the set of parent beams and the at least one activated set of child beams.

### CROSS-REFERENCE TO RELATED APPLICATIONS

The present Application for Patent claims the benefit of GR Application No. 20210100512, entitled “PARENT AND CHILD POSITIONING REFERENCE SIGNAL RESOURCE SET CONFIGURATIONS”, filed Jul. 28, 2021, and is a national stage application, filed under 35 U.S.C. § 371, of International Patent Application No. PCT/US2022/072733, entitled, “PARENT AND CHILD POSITIONING REFERENCE SIGNAL RESOURCE SET CONFIGURATIONS”, filed Jun. 2, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a user equipment (UE) includes receiving, from a position estimation entity, a parent positioning reference signal (PRS) resource set configuration associated with a set of parent beams from a transmission reception point (TRP): receiving, from the position estimation entity, a set of child PRS resource set configurations associated with a respective set of child beams for each of the set of parent beams, each set of child beams including one or more child beams for a respective parent beam that are each narrower than a beamwidth of the respective parent beam; performing. one or more measurements associated with the set of parent beams in accordance with the parent PRS resource set configuration; reporting the one or more measurements associated with the set of parent beams; and determining at least one activated set of child beams of at least one activated child PRS resource set configuration based on the one or more measurements; and performing one or more measurements associated with the at least one activated set of child beams of the at least one activated child PRS resource set configuration in accordance with at least one respective child PRS resource set configuration.

In some aspects, the set of child PRS resource set configurations includes a plurality of child PRS resource set configurations, and each of the plurality of child PRS resource set configurations is associated with a different parent beam among the set of parent beams.

In some aspects, a default child PRS resource set is designated via assistance data (AD), and the at least one activated child PRS resource set configuration corresponds to the default child PRS resource set or is modified from the default child PRS resource set configuration based on the one or more measurements of the set of parent beams.

In some aspects, the set of child PRS resource set configurations includes a single child PRS resource set configuration, and the single child PRS resource set configuration includes the respective set of child beams for each of the set of parent beams.

In some aspects, the method includes determining, for each parent beam among the set of parent beams, an association between its respective set of child beams.

In some aspects, the association comprises a beamwidth threshold, a boresight direction threshold, or a combination thereof.

In some aspects, the at least one activated set of child beams includes a single activated set of child beams associated with a best parent beam in terms of one or more performance metrics based on the one or more measurements associated with the set of parent beams.

In some aspects, the at least one activated set of child beams includes multiple activated sets of child beams associated with N best parent beams in terms of one or more performance metrics based on the one or more measurements associated with the set of parent beams.

In some aspects, the one or more measurements associated with the set of parent beams and the one or more measurements associated with the at least one activated set of child beams are performed during the same measurement period.

In some aspects, the set of parent beams and the at least one activated set of child beams are associated with the same frequency layer, or the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

In some aspects, the method includes transmitting, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

In some aspects, each child beam is associated with a narrower beamwidth than its respective parent beam.

In some aspects, the set of parent beams is transmitted by the TRP at a first periodicity, and one or more of the sets of child beams are transmitted by the TRP at a second periodicity that is shorter than the first periodicity.

In some aspects, a given child beam is included in respective sets of child beams for two or more respective parent beams.

In an aspect, a method of operating a position estimation entity includes transmitting, to a user equipment (UE), a parent positioning reference signal (PRS) resource set configuration associated with a set of parent beams from a transmission reception point (TRP): transmitting, to the UE, a set of child PRS resource set configurations associated with a respective set of child beams for each of the set of parent beams, each set of child beams including one or more child beams for a respective parent beam that are each narrower than a beamwidth of the respective parent beam; and receiving, from the UE, at least one measurement report based on one or more measurements associated with the set of parent beams in accordance with the parent PRS resource set configuration, and one or more measurements associated with at least one activated set of child beams of at least one activated child PRS resource set configuration.

In some aspects, the set of child PRS resource set configurations includes a plurality of child PRS resource set configurations, and each of the plurality of child PRS resource set configurations is associated with a different parent beam among the set of parent beams.

In some aspects, the set of child PRS resource set configurations includes a single child PRS resource set configuration, and the single child PRS resource set configuration includes the respective set of child beams for each of the set of parent beams.

In some aspects, the at least one activated set of child beams includes a single set of child beams associated with a best parent beam in terms of one or more performance metrics based on the one or more measurements associated with the set of parent beams.

In some aspects, the at least one activated set of child beams includes multiple activated sets of child beams associated with N best parent beams in terms of one or more performance metrics based on the one or more measurements of the set of parent beams.

In some aspects, the one or more measurements associated with the set of parent beams and the one or more measurements associated with the at least one activated set of child beams are performed during the same measurement period.

In some aspects, the set of parent beams and the at least one activated set of child beams are associated with the same frequency layer, or the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

In some aspects, the method includes receiving, from the UE, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

In some aspects, each child beam is associated with a narrower beamwidth than its respective parent beam.

In some aspects, the at least one measurement report comprises multiple measurement reports.

In an aspect, a user equipment (UE) includes a memory; at least one transceiver; and at least one processor communicatively coupled to the memory and the at least one transceiver, the at least one processor configured to: receive, via the at least one transceiver, from a position estimation entity, a parent positioning reference signal (PRS) resource set configuration associated with a set of parent beams from a transmission reception point (TRP); receive, via the at least one transceiver, from the position estimation entity, a set of child PRS resource set configurations associated with a respective set of child beams for each of the set of parent beams, each set of child beams including one or more child beams for a respective parent beam that are each narrower than a beamwidth of the respective parent beam; perform, one or more measurements associated with the set of parent beams in accordance with the parent PRS resource set configuration: report the one or more measurements associated with the set of parent beams; and determine at least one activated set of child beams of at least one activated child PRS resource set configuration based on the one or more measurements; and perform one or more measurements associated with the at least one activated set of child beams of the at least one activated child PRS resource set configuration in accordance with at least one respective child PRS resource set configuration.

In some aspects, the set of child PRS resource set configurations includes a plurality of child PRS resource set configurations, and each of the plurality of child PRS resource set configurations is associated with a different parent beam among the set of parent beams.

In some aspects, a default child PRS resource set is designated via assistance data (AD), and the at least one activated child PRS resource set configuration corresponds to the default child PRS resource set or is modified from the default child PRS resource set configuration based on the one or more measurements of the set of parent beams.

In some aspects, the set of child PRS resource set configurations includes a single child PRS resource set configuration, and the single child PRS resource set configuration includes the respective set of child beams for each of the set of parent beams.

In some aspects, the at least one processor is further configured to: determine, for each parent beam among the set of parent beams, an association between its respective set of child beams.

In some aspects, the association comprises a beamwidth threshold, a boresight direction threshold, or a combination thereof.

In some aspects, the at least one activated set of child beams includes a single activated set of child beams associated with a best parent beam in terms of one or more performance metrics based on the one or more measurements associated with the set of parent beams.

In some aspects, the at least one activated set of child beams includes multiple activated sets of child beams associated with N best parent beams in terms of one or more performance metrics based on the one or more measurements associated with the set of parent beams.

In some aspects, the one or more measurements associated with the set of parent beams and the one or more measurements associated with the at least one activated set of child beams are performed during the same measurement period.

In some aspects, the set of parent beams and the at least one activated set of child beams are associated with the same frequency layer, or the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

In some aspects, the at least one processor is further configured to: transmit, via the at least one transceiver, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

In some aspects, each child beam is associated with a narrower beamwidth than its respective parent beam.

In some aspects, the set of parent beams is transmitted by the TRP at a first periodicity, and one or more of the sets of child beams are transmitted by the TRP at a second periodicity that is shorter than the first periodicity.

In some aspects, a given child beam is included in respective sets of child beams for two or more respective parent beams.

In an aspect, a position estimation entity includes a memory; at least one transceiver; and at least one processor communicatively coupled to the memory and the at least one transceiver, the at least one processor configured to: transmit, via the at least one transceiver, to a user equipment (UE), a parent positioning reference signal (PRS) resource set configuration associated with a set of parent beams from a transmission reception point (TRP); transmit, via the at least one transceiver, to the UE, a set of child PRS resource set configurations associated with a respective set of child beams for each of the set of parent beams, each set of child beams including one or more child beams for a respective parent beam that are each narrower than a beamwidth of the respective parent beam; and receive, via the at least one transceiver, from the UE, at least one measurement report based on one or more measurements associated with the set of parent beams in accordance with the parent PRS resource set configuration, and one or more measurements associated with at least one activated set of child beams of at least one activated child PRS resource set configuration.

In some aspects, the set of child PRS resource set configurations includes a plurality of child PRS resource set configurations, and each of the plurality of child PRS resource set configurations is associated with a different parent beam among the set of parent beams.

In some aspects, the set of child PRS resource set configurations includes a single child PRS resource set configuration, and the single child PRS resource set configuration includes the respective set of child beams for each of the set of parent beams.

In some aspects, the at least one activated set of child beams includes a single set of child beams associated with a best parent beam in terms of one or more performance metrics based on the one or more measurements associated with the set of parent beams.

In some aspects, the at least one activated set of child beams includes multiple activated sets of child beams associated with N best parent beams in terms of one or more performance metrics based on the one or more measurements of the set of parent beams.

In some aspects, the one or more measurements associated with the set of parent beams and the one or more measurements associated with the at least one activated set of child beams are performed during the same measurement period.

In some aspects, the set of parent beams and the at least one activated set of child beams are associated with the same frequency layer, or the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

In some aspects, the at least one processor is further configured to: receive, via the at least one transceiver, from the UE, an indication of a capability of the UE to support a parent-to-child beam association between parent and child beams within the same frequency layer, within different frequency layers in the same bandwidth of a frequency range, within different frequency layers of different bandwidths of different frequency ranges. or a combination thereof.

In some aspects, each child beam is associated with a narrower beamwidth than its respective parent beam.

In some aspects, the at least one measurement report comprises multiple measurement reports.

In an aspect, a user equipment (UE) includes means for receiving, from a position estimation entity, a parent positioning reference signal (PRS) resource set configuration associated with a set of parent beams from a transmission reception point (TRP): means for receiving, from the position estimation entity, a set of child PRS resource set configurations associated with a respective set of child beams for each of the set of parent beams, each set of child beams including one or more child beams for a respective parent beam that are each narrower than a beamwidth of the respective parent beam: means for performing, one or more measurements associated with the set of parent beams in accordance with the parent PRS resource set configuration; means for reporting the one or more measurements associated with the set of parent beams; and means for determining at least one activated set of child beams of at least one activated child PRS resource set configuration based on the one or more measurements; and means for performing one or more measurements associated with the at least one activated set of child beams of the at least one activated child PRS resource set configuration in accordance with at least one respective child PRS resource set configuration.

In some aspects, the set of child PRS resource set configurations includes a plurality of child PRS resource set configurations, and each of the plurality of child PRS resource set configurations is associated with a different parent beam among the set of parent beams.

In some aspects, a default child PRS resource set is designated via assistance data (AD), and the at least one activated child PRS resource set configuration corresponds to the default child PRS resource set or is modified from the default child PRS resource set configuration based on the one or more measurements of the set of parent beams.

In some aspects, the set of child PRS resource set configurations includes a single child PRS resource set configuration, and the single child PRS resource set configuration includes the respective set of child beams for each of the set of parent beams.

In some aspects, the method includes means for determining, for each parent beam among the set of parent beams, an association between its respective set of child beams.

In some aspects, the association comprises a beamwidth threshold, a boresight direction threshold, or a combination thereof.

In some aspects, the at least one activated set of child beams includes a single activated set of child beams associated with a best parent beam in terms of one or more performance metrics based on the one or more measurements associated with the set of parent beams.

In some aspects, the at least one activated set of child beams includes multiple activated sets of child beams associated with N best parent beams in terms of one or more performance metrics based on the one or more measurements associated with the set of parent beams.

In some aspects, the one or more measurements associated with the set of parent beams and the one or more measurements associated with the at least one activated set of child beams are performed during the same measurement period.

In some aspects, the set of parent beams and the at least one activated set of child beams are associated with the same frequency layer, or the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

In some aspects, the method includes means for transmitting, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

In some aspects, each child beam is associated with a narrower beamwidth than its respective parent beam.

In some aspects, the set of parent beams is transmitted by the TRP at a first periodicity, and one or more of the sets of child beams are transmitted by the TRP at a second periodicity that is shorter than the first periodicity.

In some aspects, a given child beam is included in respective sets of child beams for two or more respective parent beams.

In an aspect, a position estimation entity includes means for transmitting, to a user equipment (UE), a parent positioning reference signal (PRS) resource set configuration associated with a set of parent beams from a transmission reception point (TRP): means for transmitting, to the UE, a set of child PRS resource set configurations associated with a respective set of child beams for each of the set of parent beams, each set of child beams including one or more child beams for a respective parent beam that are each narrower than a beamwidth of the respective parent beam; and means for receiving, from the UE, at least one measurement report based on one or more measurements associated with the set of parent beams in accordance with the parent PRS resource set configuration, and one or more measurements associated with at least one activated set of child beams of at least one activated child PRS resource set configuration.

In some aspects, the set of child PRS resource set configurations includes a plurality of child PRS resource set configurations, and each of the plurality of child PRS resource set configurations is associated with a different parent beam among the set of parent beams.

In some aspects, the set of child PRS resource set configurations includes a single child PRS resource set configuration, and the single child PRS resource set configuration includes the respective set of child beams for each of the set of parent beams.

In some aspects, the at least one activated set of child beams includes a single set of child beams associated with a best parent beam in terms of one or more performance metrics based on the one or more measurements associated with the set of parent beams.

In some aspects, the at least one activated set of child beams includes multiple activated sets of child beams associated with N best parent beams in terms of one or more performance metrics based on the one or more measurements of the set of parent beams.

In some aspects, the one or more measurements associated with the set of parent beams and the one or more measurements associated with the at least one activated set of child beams are performed during the same measurement period.

In some aspects, the set of parent beams and the at least one activated set of child beams are associated with the same frequency laver, or the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

In some aspects, the method includes means for receiving, from the UE, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

In some aspects, each child beam is associated with a narrower beamwidth than its respective parent beam.

In some aspects, the at least one measurement report comprises multiple measurement reports.

In an aspect, a non-transitory computer-readable medium storing computer-executable instructions that, when executed by a user equipment (UE), cause the UE to: receive, from a position estimation entity, a parent positioning reference signal (PRS) resource set configuration associated with a set of parent beams from a transmission reception point (TRP); receive, from the position estimation entity, a set of child PRS resource set configurations associated with a respective set of child beams for each of the set of parent beams, each set of child beams including one or more child beams for a respective parent beam that are each narrower than a beamwidth of the respective parent beam: perform, one or more measurements associated with the set of parent beams in accordance with the parent PRS resource set configuration: report the one or more measurements associated with the set of parent beams; and determine at least one activated set of child beams of at least one activated child PRS resource set configuration based on the one or more measurements; and perform one or more measurements associated with the at least one activated set of child beams of the at least one activated child PRS resource set configuration in accordance with at least one respective child PRS resource set configuration.

In some aspects, the set of child PRS resource set configurations includes a plurality of child PRS resource set configurations, and each of the plurality of child PRS resource set configurations is associated with a different parent beam among the set of parent beams.

In some aspects, a default child PRS resource set is designated via assistance data (AD), and the at least one activated child PRS resource set configuration corresponds to the default child PRS resource set or is modified from the default child PRS resource set configuration based on the one or more measurements of the set of parent beams.

In some aspects, the set of child PRS resource set configurations includes a single child PRS resource set configuration, and the single child PRS resource set configuration includes the respective set of child beams for each of the set of parent beams.

In some aspects, instructions that, when executed by UE, further cause the UE to: determine, for each parent beam among the set of parent beams, an association between its respective set of child beams.

In some aspects, the association comprises a beamwidth threshold, a boresight direction threshold, or a combination thereof.

In some aspects, the at least one activated set of child beams includes a single activated set of child beams associated with a best parent beam in terms of one or more performance metrics based on the one or more measurements associated with the set of parent beams.

In some aspects, the at least one activated set of child beams includes multiple activated sets of child beams associated with N best parent beams in terms of one or more performance metrics based on the one or more measurements associated with the set of parent beams.

In some aspects, the one or more measurements associated with the set of parent beams and the one or more measurements associated with the at least one activated set of child beams are performed during the same measurement period.

In some aspects, the set of parent beams and the at least one activated set of child beams are associated with the same frequency layer, or the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

In some aspects, instructions that, when executed by UE, further cause the UE to: transmit, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

In some aspects, each child beam is associated with a narrower beamwidth than its respective parent beam.

In some aspects, the set of parent beams is transmitted by the TRP at a first periodicity, and one or more of the sets of child beams are transmitted by the TRP at a second periodicity that is shorter than the first periodicity.

In some aspects, a given child beam is included in respective sets of child beams for two or more respective parent beams.

In an aspect, a non-transitory computer-readable medium storing computer-executable instructions that, when executed by a position estimation entity, cause the position estimation entity to: transmit, to a user equipment (UE), a parent positioning reference signal (PRS) resource set configuration associated with a set of parent beams from a transmission reception point (TRP): transmit, to the UE, a set of child PRS resource set configurations associated with a respective set of child beams for each of the set of parent beams, each set of child beams including one or more child beams for a respective parent beam that are each narrower than a beamwidth of the respective parent beam; and receive, from the UE, at least one measurement report based on one or more measurements associated with the set of parent beams in accordance with the parent PRS resource set configuration, and one or more measurements associated with at least one activated set of child beams of at least one activated child PRS resource set configuration.

In some aspects, the set of child PRS resource set configurations includes a plurality of child PRS resource set configurations, and each of the plurality of child PRS resource set configurations is associated with a different parent beam among the set of parent beams.

In some aspects, the set of child PRS resource set configurations includes a single child PRS resource set configuration, and the single child PRS resource set configuration includes the respective set of child beams for each of the set of parent beams.

In some aspects, the at least one activated set of child beams includes a single set of child beams associated with a best parent beam in terms of one or more performance metrics based on the one or more measurements associated with the set of parent beams.

In some aspects, the at least one activated set of child beams includes multiple activated sets of child beams associated with N best parent beams in terms of one or more performance metrics based on the one or more measurements of the set of parent beams.

In some aspects, the one or more measurements associated with the set of parent beams and the one or more measurements associated with the at least one activated set of child beams are performed during the same measurement period.

In some aspects, the set of parent beams and the at least one activated set of child beams are associated with the same frequency layer, or the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

In some aspects, instructions that, when executed by the position estimation entity, further cause the position estimation entity to: receive, from the UE, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

In some aspects, each child beam is associated with a narrower beamwidth than its respective parent beam.

In some aspects, the at least one measurement report comprises multiple measurement reports.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 is a diagram of an example positioning reference signal (PRS) configuration for the PRS transmissions of a given base station, according to aspects of the disclosure.

FIG. 7 illustrates examples of various positioning methods, according to aspects of the disclosure.

FIG. 8 is a diagram illustrating an example base station in communication with an example UE, according to aspects of the disclosure.

FIG. 9 is a diagram illustrating an example downlink positioning reference signal (DL-PRS) configuration for two transmission-reception points (TRPs) operating in the same positioning frequency layer, according to aspects of the disclosure.

FIG. 10 illustrates a parent beam configuration in accordance with an aspect of the disclosure.

FIG. 11 illustrates a child beam configuration in accordance with an aspect of the disclosure.

FIG. 12 illustrates an exemplary process of wireless communication, according to aspects of the disclosure.

FIG. 13 illustrates an exemplary process of wireless communication, according to aspects of the disclosure.

FIG. 14 illustrates an example implementation of the processes of FIGS. 12-13, respectively, in accordance with aspects of the disclosure.

FIG. 15 illustrates an example implementation of the processes of FIGS. 12-13, respectively, in accordance with aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.). Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station.” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

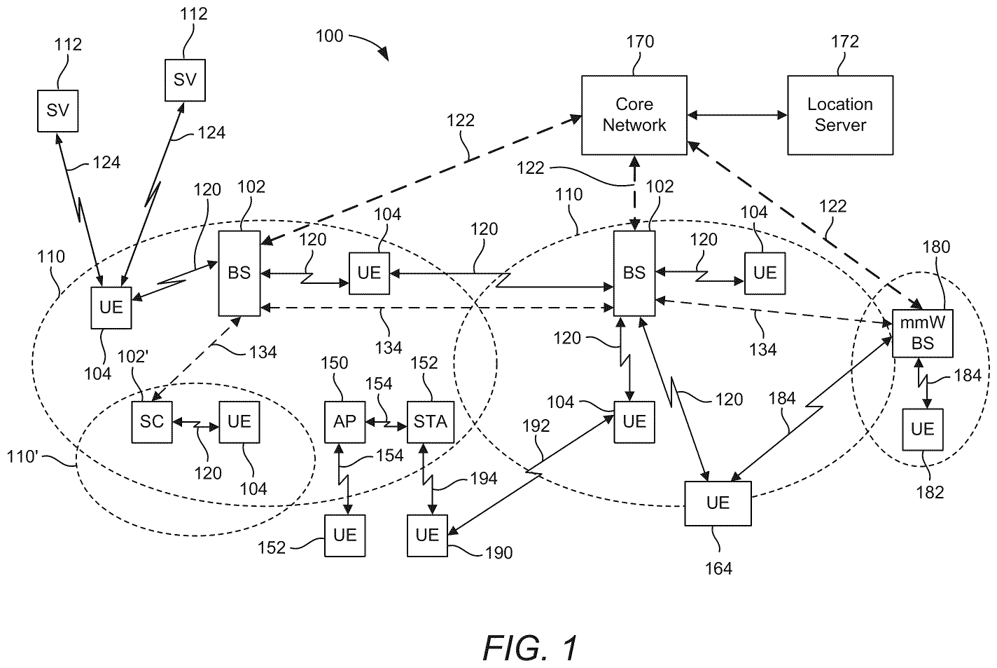

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages. NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g. through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mm W) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHZ). FR3 (above 52600 MHz), and FR4 (between FR1 and FR2), mmW frequency bands generally include the FR2, FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier.” “carrier frequency.” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect. SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

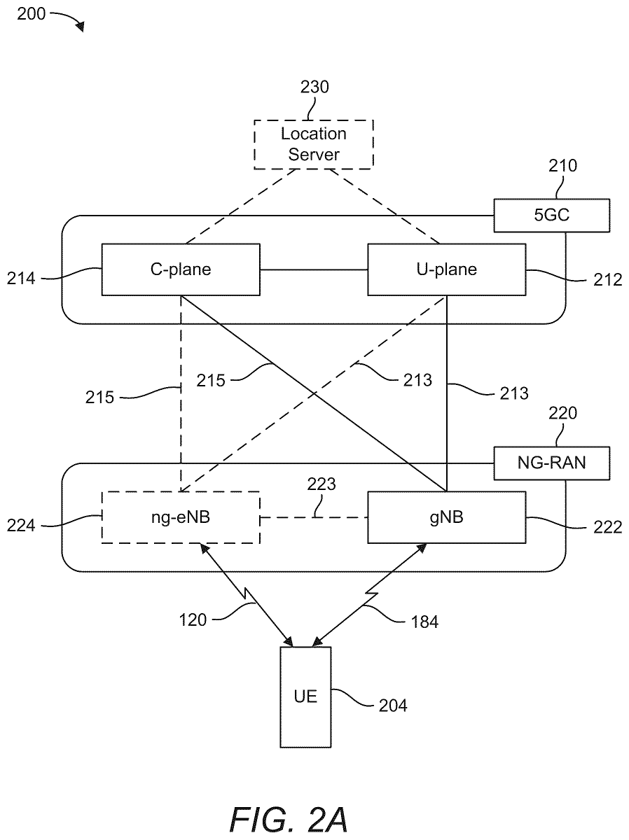

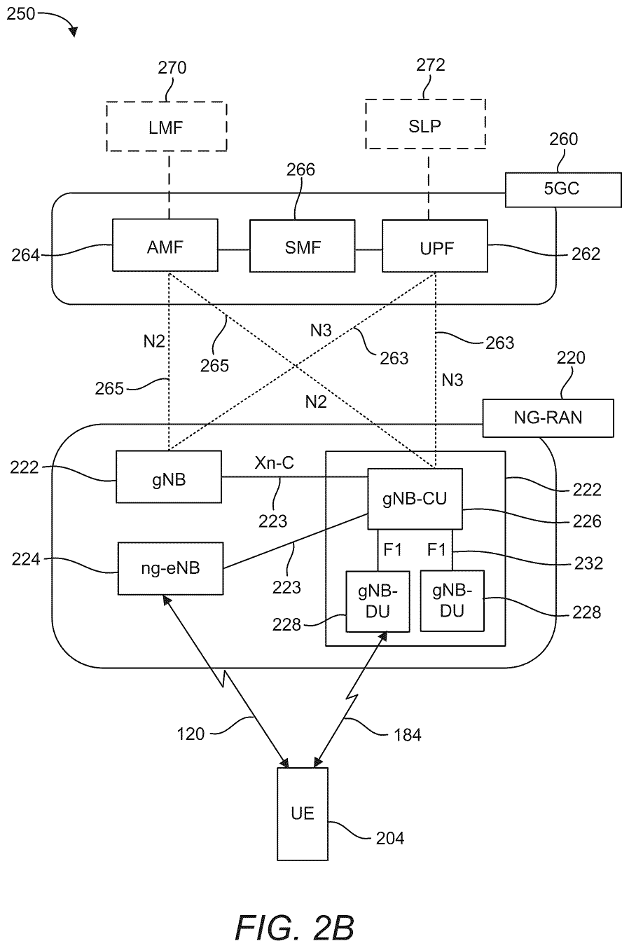

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-cNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 is divided between a gNB central unit (gNB-CU) 226 and one or more gNB distributed units (gNB-DUs) 228. The interface 232 between the gNB-CU 226 and the one or more gNB-DUs 228 is referred to as the “F1” interface. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 hosts the radio resource control (RRC), service data adaptation protocol (SDAP), and packet data convergence protocol (PDCP) protocols of the gNB 222. A gNB-DU 228 is a logical node that hosts the radio link control (RLC), medium access control (MAC), and physical (PHY) layers of the gNB 222. Its operation is controlled by the gNB-CU 226. One gNB-DU 228 can support one or more cells, and one cell is supported by only one gNB-DU 228. Thus, a UE 204 communicates with the gNB-CU 226 via the RRC, SDAP, and PDCP layers and with a gNB-DU 228 via the RLC. MAC, and PHY layers.

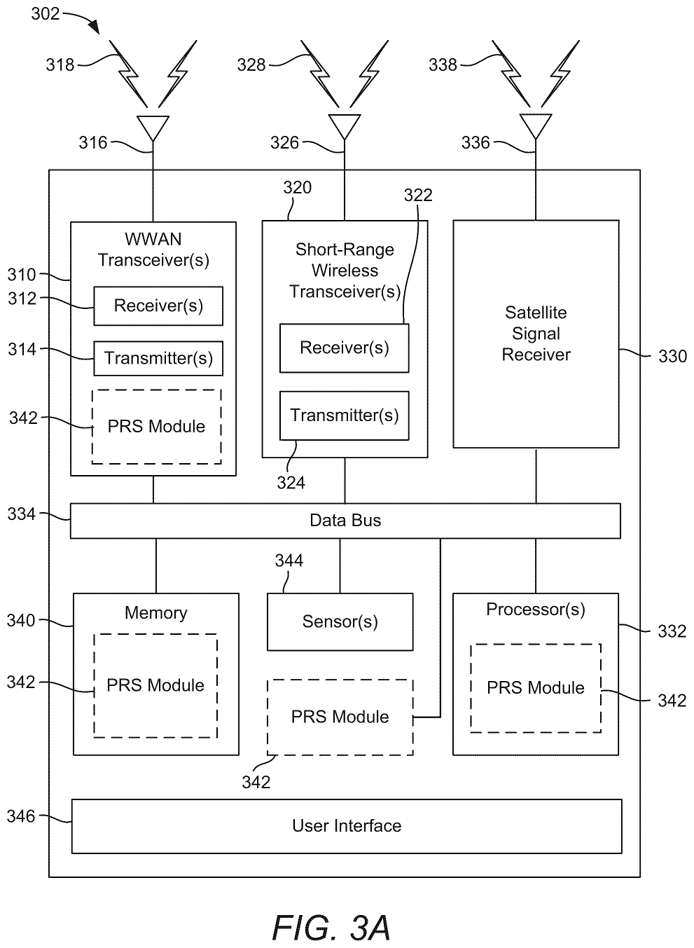

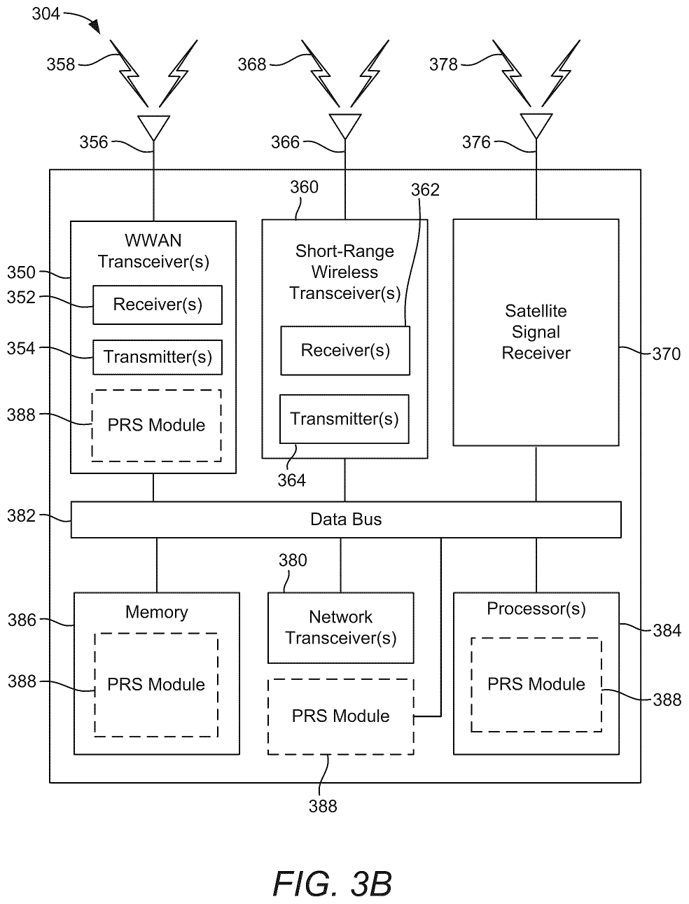

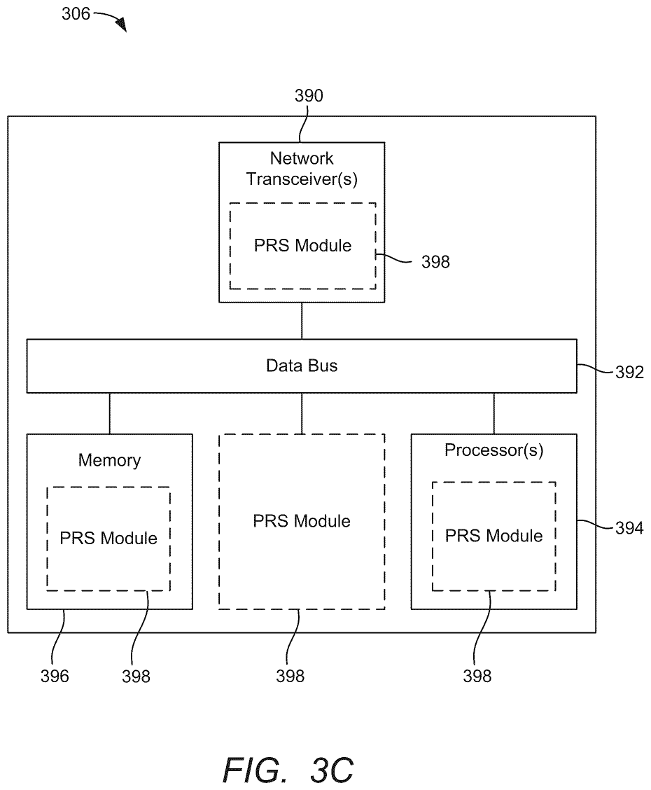

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth R), Zigbee R), Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee R and/or Z-WaveR) transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver.” “at least one transceiver.” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include PRS module 342, 388, and 398, respectively. The PRS module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the PRS module 342, 388, and 398 may be external to the processors 332, 384, and 394 (e.g., part of a modem processing system, integrated with another processing system, etc.).

Alternatively, the PRS module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the PRS module 342, which may be, for example, part of the one or more WWAN transceivers 310, the memory 340, the one or more processors 332, or any combination thereof, or may be a standalone component. FIG. 3B illustrates possible locations of the PRS module 388, which may be, for example, part of the one or more WWAN transceivers 350, the memory 386, the one or more processors 384, or any combination thereof, or may be a standalone component. FIG. 3C illustrates possible locations of the PRS module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting: PDCP layer functionality associated with header compression/decompression, security (ciphering, deciphering, integrity protection, integrity verification), and handover support functions: RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification): RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering. header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE.” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the PRS module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

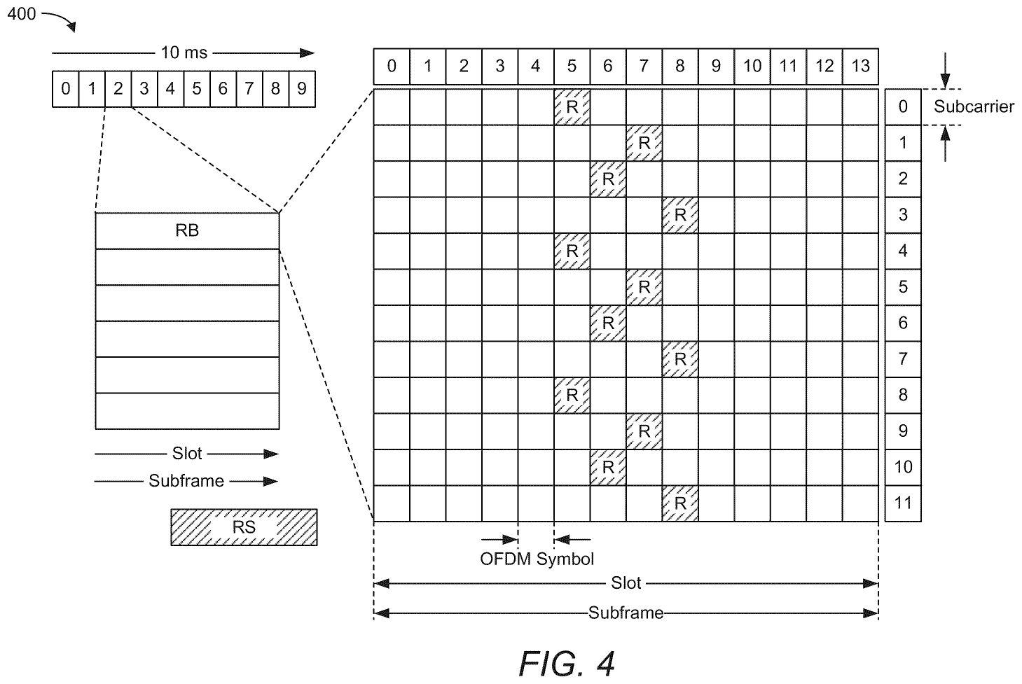

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones. bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (pμ0). 30 kHz (μ=1), 60 kHz (μ=2). 120 kHz (μ=3), and 240 kHz (μ=4) or greater may be available. In each subcarrier spacing, there are 14 symbols per slot. For 15 kHz SCS (pμ0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (pμ1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (pμ2), there are four slots per subframe. 40 slots per frame, the slot duration is 0.25 ms, the symbol duration is 16.7 μs, and the maximum nominal system bandwidth (in MHz) with a 4K FFT size is 200. For 120 kHz SCS (pμ3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 KHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

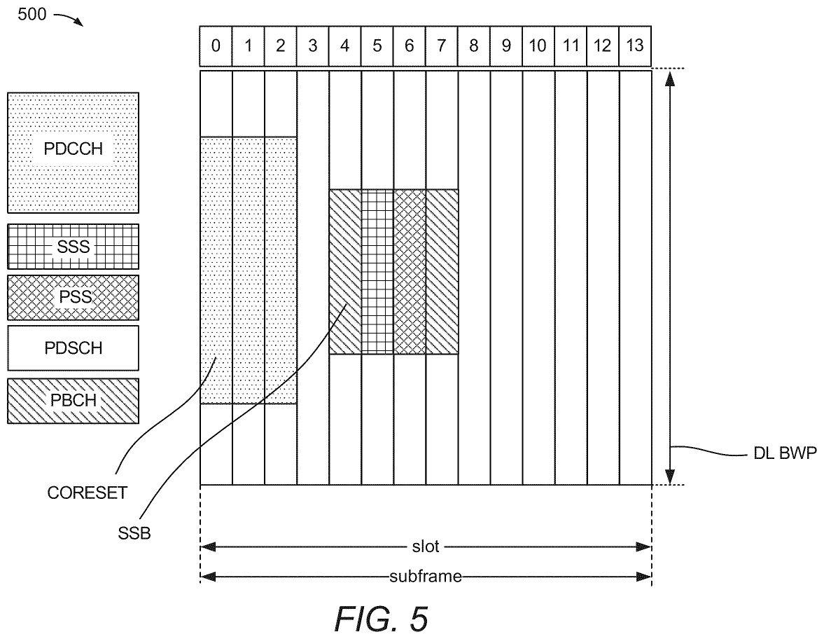

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size “N” represents the subcarrier spacing (or frequency/tone spacing) within each symbol of a PRS resource configuration.

Specifically, for a comb size ‘N,’ PRS are transmitted in every Nth subcarrier of a symbol of a PRB. For example, for comb-4, for each symbol of the PRS resource configuration. REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}: 4-symbol comb-2: {0, 1, 0, 1}: 6-symbol comb-2: {0, 1, 0, 1, 0, 1}: 12-symbol comb-2: {0, 1, 0, 1, 0, 1, 0, 1, 0, 1, 0, 1}; 4-symbol comb-4: {0, 2, 1, 3} (as in the example of FIG. 4): 12-symbol comb-4: {0, 2, 1, 3, 0, 2, 1, 3, 0, 2, 1, 3}: 6-symbol comb-6: {0, 3, 1, 4, 2, 5}: 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with u=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion.” a “PRS positioning instance, a “positioning occasion,” “a positioning instance.” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (μsually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning. PTRS) may be referred to as an “UL-PRS.” In addition, for signals that may be transmitted in both the uplink and downlink (e.g., DMRS. PTRS), the signals may be prepended with “UL” or “DL” to distinguish the direction. For example, “UL-DMRS” may be differentiated from “DL-DMRS.”

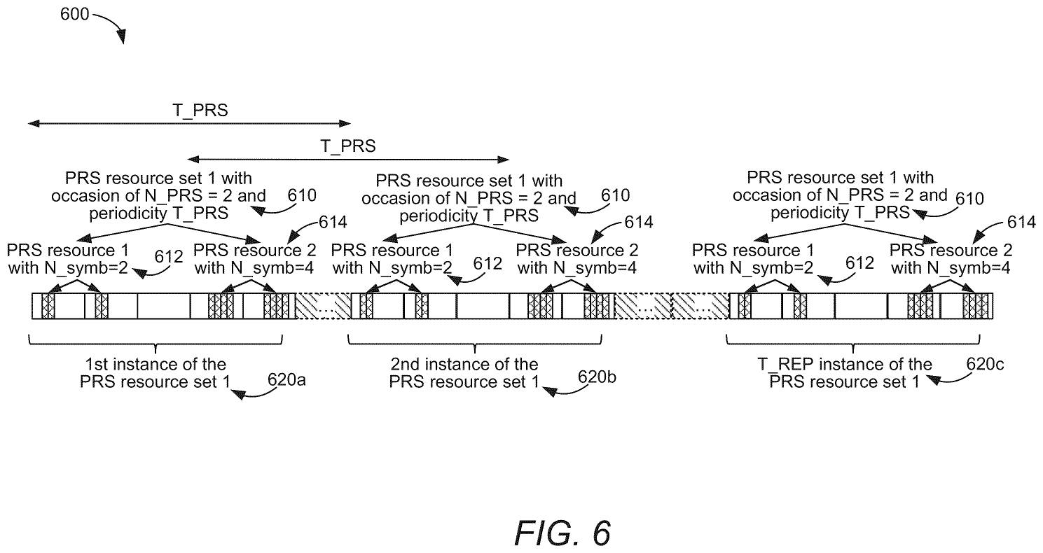

FIG. 6 is a diagram of an example PRS configuration 600 for the PRS transmissions of a given base station, according to aspects of the disclosure. In FIG. 6, time is represented horizontally, increasing from left to right. Each long rectangle represents a slot and each short (shaded) rectangle represents an OFDM symbol. In the example of FIG. 6, a PRS resource set 610 (labeled “PRS resource set 1”) includes two PRS resources, a first PRS resource 612 (labeled “PRS resource 1”) and a second PRS resource 514 (labeled “PRS resource 2”). The base station transmits PRS on the PRS resources 612 and 614 of the PRS resource set 610.

The PRS resource set 610 has an occasion length (N_PRS) of two slots and a periodicity (T_PRS) of, for example, 160 slots or 160 milliseconds (ms) (for 15 kHz subcarrier spacing). As such, both the PRS resources 612 and 614 are two consecutive slots in length and repeat every T_PRS slots, starting from the slot in which the first symbol of the respective PRS resource occurs. In the example of FIG. 6, the PRS resource 612 has a symbol length (N_symb) of two symbols, and the PRS resource 614 has a symbol length (N_symb) of four symbols. The PRS resource 612 and the PRS resource 614 may be transmitted on separate beams of the same base station.

Each instance of the PRS resource set 610, illustrated as instances 620a, 620b, and 620c, includes an occasion of length “2” (i.e., N_PRS=2) for each PRS resource 612, 614 of the PRS resource set. The PRS resources 612 and 614 are repeated every T_PRS slots up to the muting sequence periodicity T_REP. As such, a bitmap of length T_REP would be needed to indicate which occasions of instances 620a, 620b, and 620c of PRS resource set 610 are muted (i.e., not transmitted).

In an aspect, there may be additional constraints on the PRS configuration 600. For example, for all PRS resources (e.g., PRS resources 612, 614) of a PRS resource set (e.g., PRS resource set 610), the base station can configure the following parameters to be the same: (a) the occasion length (T_PRS), (b) the number of symbols (N_symb), (c) the comb type, and/or (d) the bandwidth. In addition, for all PRS resources of all PRS resource sets, the subcarrier spacing and the cyclic prefix can be configured to be the same for one base station or for all base stations. Whether it is for one base station or all base stations may depend on the UE's capability to support the first and/or second option.

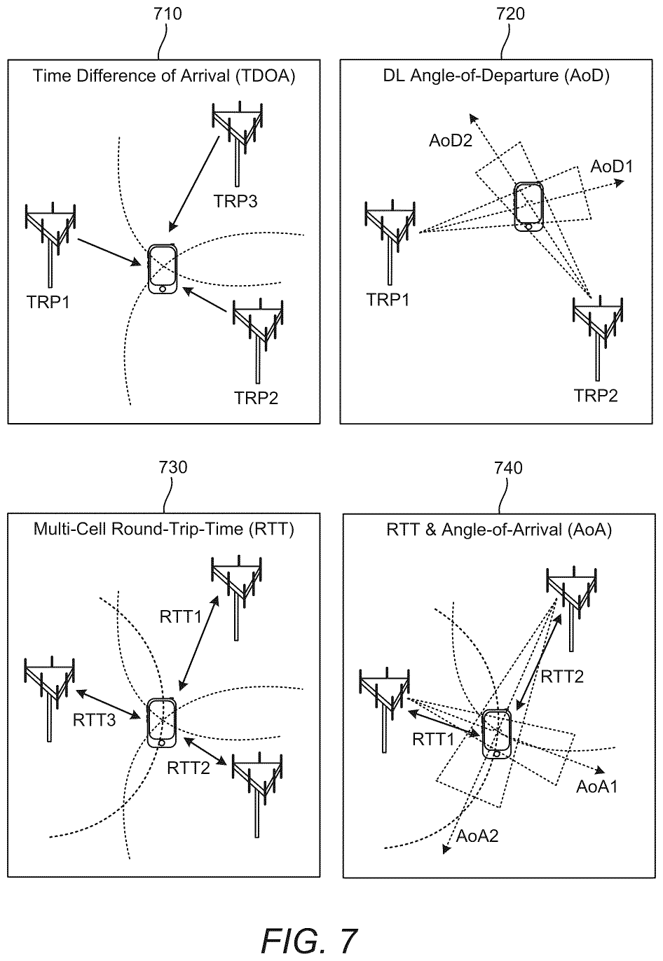

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 7 illustrates examples of various positioning methods, according to aspects of the disclosure. In an OTDOA or DL-TDOA positioning procedure, illustrated by scenario 710, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity can estimate the UE's location.

For DL-AoD positioning, illustrated by scenario 720, the positioning entity uses a beam report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE. For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT”). In an RTT procedure, an initiator (a base station or a UE) transmits an RTT measurement signal (e.g., a PRS or SRS) to a responder (a UE or base station), which transmits an RTT response signal (e.g., an SRS or PRS) back to the initiator. The RTT response signal includes the difference between the ToA of the RTT measurement signal and the transmission time of the RTT response signal, referred to as the reception-to-transmission (Rx-Tx) time difference. The initiator calculates the difference between the transmission time of the RTT measurement signal and the ToA of the RTT response signal, referred to as the transmission-to-reception (Tx-Rx) time difference. The propagation time (also referred to as the “time of flight”) between the initiator and the responder can be calculated from the Tx-Rx and Rx-Tx time differences. Based on the propagation time and the known speed of light, the distance between the initiator and the responder can be determined. For multi-RTT positioning, illustrated by scenario 730, a UE performs an RTT procedure with multiple base stations to enable its location to be determined (e.g., using multilateration) based on the known locations of the base stations. RTT and multi-RTT methods can be combined with other positioning techniques, such as UL-AoA, illustrated by scenario 740, and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270. SLP 272) may provide assistance data to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

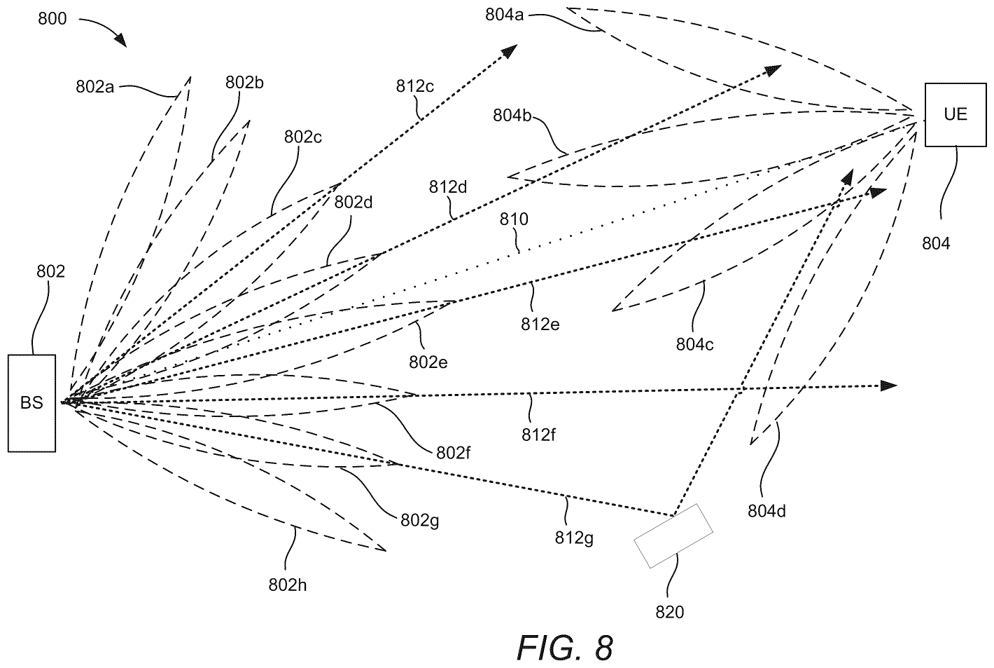

FIG. 8 is a diagram 800 illustrating a base station (BS) 802 (which may correspond to any of the base stations described herein) in communication with a UE 804 (which may correspond to any of the UEs described herein). Referring to FIG. 8, the base station 802 may transmit a beamformed signal to the UE 804 on one or more transmit beams 802a. 802b, 802c, 802d, 802e, 802f, 802g, 802h, each having a beam identifier that can be used by the UE 804 to identify the respective beam. Where the base station 802 is beamforming towards the UE 804 with a single array of antennas (e.g., a single TRP/cell), the base station 802 may perform a “beam sweep” by transmitting first beam 802a, then beam 802b, and so on until lastly transmitting beam 802h. Alternatively, the base station 802 may transmit beams 802a-802h in some pattern, such as beam 802a, then beam 802h, then beam 802b, then beam 802g, and so on. Where the base station 802 is beamforming towards the UE 804 using multiple arrays of antennas (e.g., multiple TRPs/cells), each antenna array may perform a beam sweep of a subset of the beams 802a-802h. Alternatively, each of beams 802a-802h may correspond to a single antenna or antenna array.

FIG. 8 further illustrates the paths 812c. 812d, 812e, 812f, and 812g followed by the beamformed signal transmitted on beams 802c, 802d, 802e, 802f, and 802g, respectively. Each path 812c. 812d, 812e, 812f, 812g may correspond to a single “multipath” or, due to the propagation characteristics of radio frequency (RF) signals through the environment, may be comprised of a plurality (a cluster) of “multipaths.” Note that although only the paths for beams 802c-802g are shown, this is for simplicity, and the signal transmitted on each of beams 802a-802b will follow some path. In the example shown, the paths 812c, 812d, 812e, and 812f are straight lines, while path 812g reflects off an obstacle 820 (e.g., a building, vehicle, terrain feature, etc.).

The UE 804 may receive the beamformed signal from the base station 802 on one or more receive beams 804a, 804b. 804c. 804d. Note that for simplicity, the beams illustrated in FIG. 8 represent either transmit beams or receive beams, depending on which of the base station 802 and the UE 804 is transmitting and which is receiving. Thus, the UE 804 may also transmit a beamformed signal to the base station 802 on one or more of the beams 804a-804d, and the base station 802 may receive the beamformed signal from the UE 804 on one or more of the beams 802a-802h.

In an aspect, the base station 802 and the UE 804 may perform beam training to align the transmit and receive beams of the base station 802 and the UE 804. For example, depending on environmental conditions and other factors, the base station 802 and the UE 804 may determine that the best transmit and receive beams are 802d and 804b, respectively, or beams 802e and 804c, respectively. The direction of the best transmit beam for the base station 802 may or may not be the same as the direction of the best receive beam, and likewise, the direction of the best receive beam for the UE 804 may or may not be the same as the direction of the best transmit beam. Note, however, that aligning the transmit and receive beams is not necessary to perform a downlink angle-of-departure (DL-AoD) or uplink angle-of-arrival (UL-AoA) positioning procedure.

To perform a DL-AoD positioning procedure, the base station 802 may transmit reference signals (e.g., PRS. CRS, TRS. CSI-RS, PSS, SSS, etc.) to the UE 804 on one or more of beams 802a-802h, with each beam having a different transmit angle. The different transmit angles of the beams will result in different received signal strengths (e.g., RSRP, RSRQ. SINR, etc.) at the UE 804. Specifically, the received signal strength will be lower for transmit beams 802a-802h that are further from the line of sight (LOS) path 810 between the base station 802 and the UE 804 than for transmit beams 802a-802h that are closer to the LOS path 810.

In the example of FIG. 8, if the base station 802 transmits reference signals to the UE 804 on beams 802c, 802d, 802e, 802f, and 802g, then transmit beam 802e is best aligned with the LOS path 810, while transmit beams 802c, 802d. 802f, and 802g are not. As such, beam 802e is likely to have a higher received signal strength at the UE 804 than beams 802c. 802d, 802f, and 802g. Note that the reference signals transmitted on some beams (e.g., beams 802c and/or 802f) may not reach the UE 804, or energy reaching the UE 804 from these beams may be so low that the energy may not be detectable or at least can be ignored.

The UE 804 can report the received signal strength, and optionally, the associated measurement quality, of each measured transmit beam 802c-802g to the base station 802, or alternatively, the identity of the transmit beam having the highest received signal strength (beam 802e in the example of FIG. 8). Alternatively or additionally, if the UE 804 is also engaged in a round-trip-time (RTT) or time-difference of arrival (TDOA) positioning session with at least one base station 802 or a plurality of base stations 802, respectively, the UE 804 can report reception-to-transmission (Rx-Tx) time difference or reference signal time difference (RSTD) measurements (and optionally the associated measurement qualities), respectively, to the serving base station 802 or other positioning entity. In any case, the positioning entity (e.g., the base station 802, a location server, a third-party client, UE 804, etc.) can estimate the angle from the base station 802 to the UE 804 as the AD of the transmit beam having the highest received signal strength at the UE 804, here, transmit beam 802e.

In one aspect of DL-AoD-based positioning, where there is only one involved base station 802, the base station 802 and the UE 804 can perform a round-trip-time (RTT) procedure to determine the distance between the base station 802 and the UE 804. Thus, the positioning entity can determine both the direction to the UE 804 (μsing DL-AoD positioning) and the distance to the UE 804 (μsing RTT positioning) to estimate the location of the UE 804. Note that the AoD of the transmit beam having the highest received signal strength does not necessarily lie along the LOS path 810, as shown in FIG. 8. However, for DL-AoD-based positioning purposes, it is assumed to do so.

In another aspect of DL-AoD-based positioning, where there are multiple involved base stations 802, each involved base station 802 can report, to the serving base station 802, the determined AoD from the respective base station 802 to the UE 804, or the RSRP measurements. The serving base station 802 may then report the AoDs or RSRP measurements from the other involved base station(s) 802 to the positioning entity (e.g., UE 804 for UE-based positioning or a location server for UE-assisted positioning). With this information, and knowledge of the base stations' 802 geographic locations, the positioning entity can estimate a location of the UE 804 as the intersection of the determined AoDs. There should be at least two involved base stations 802 for a two-dimensional (2D) location solution, but as will be appreciated, the more base stations 802 that are involved in the positioning procedure, the more accurate the estimated location of the UE 804 will be.

To perform an UL-AoA positioning procedure, the UE 804 transmits uplink reference signals (e.g., UL-PRS. SRS. DMRS, etc.) to the base station 802 on one or more of uplink transmit beams 804a-804d. The base station 802 receives the uplink reference signals on one or more of uplink receive beams 802a-802h. The base station 802 determines the angle of the best receive beams 802a-802h used to receive the one or more reference signals from the UE 804 as the AoA from the UE 804 to itself. Specifically, each of the receive beams 802a-802h will result in a different received signal strength (e.g., RSRP, RSRQ, SINR, etc.) of the one or more reference signals at the base station 802. Further, the channel impulse response of the one or more reference signals will be smaller for receive beams 802a-802h that are further from the actual LOS path between the base station 802 and the UE 804 than for receive beams 802a-802h that are closer to the LOS path. Likewise, the received signal strength will be lower for receive beams 802a-802h that are further from the LOS path than for receive beams 802a-802h that are closer to the LOS path. As such, the base station 802 identifies the receive beam 802a-802h that results in the highest received signal strength and, optionally, the strongest channel impulse response, and estimates the angle from itself to the UE 804 as the AoA of that receive beam 802a-802h. Note that as with DL-AoD-based positioning, the AoA of the receive beam 802a-802h resulting in the highest received signal strength (and strongest channel impulse response if measured) does not necessarily lie along the LOS path 810. However, for UL-AoA-based positioning purposes in FR2, it may be assumed to do so.

Note that while the UE 804 is illustrated as being capable of beamforming, this is not necessary for DL-AoD and UL-AoA positioning procedures. Rather, the UE 804 may receive and transmit on an omni-directional antenna.

Where the UE 804 is estimating its location (i.e., the UE is the positioning entity), it needs to obtain the geographic location of the base station 802. The UE 804 may obtain the location from, for example, the base station 802 itself or a location server (e.g., location server 230, LMF 270, SLP 272). With the knowledge of the distance to the base station 802 (based on the RTT or timing advance), the angle between the base station 802 and the UE 804 (based on the UL-AoA of the best receive beam 802a-802h), and the known geographic location of the base station 802, the UE 804 can estimate its location.

Alternatively, where a positioning entity, such as the base station 802 or a location server, is estimating the location of the UE 804, the base station 802 reports the AoA of the receive beam 802a-802h resulting in the highest received signal strength (and optionally strongest channel impulse response) of the reference signals received from the UE 804, or all received signal strengths and channel impulse responses for all receive beams 802a-802h (which allows the positioning entity to determine the best receive beam 802a-802h). The base station 802 may additionally report the Rx-Tx time difference to the UE 804. The positioning entity can then estimate the location of the UE 804 based on the UE's 804 distance to the base station 802, the AoA of the identified receive beam 802a-802h, and the known geographic location of the base station 802.

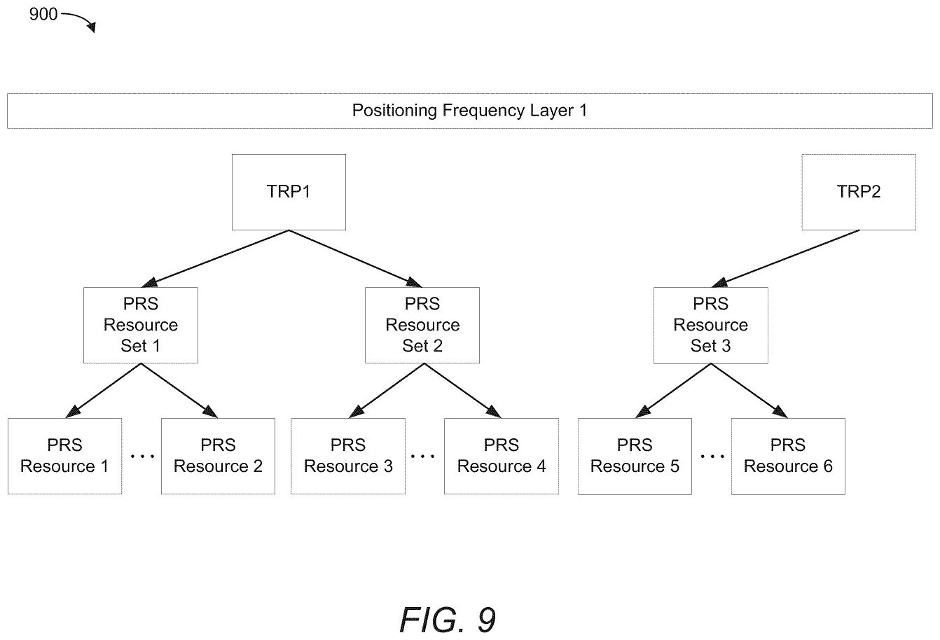

FIG. 9 is a diagram 900 illustrating an example PRS configuration for two TRPs (labeled “TRP1” and “TRP2”) operating in the same positioning frequency layer (labeled “Positioning Frequency Layer 1”), according to aspects of the disclosure. For a positioning session, a UE may be provided with assistance data indicating the illustrated PRS configuration. In the example of FIG. 9, the first TRP (“TRP1”) is associated with (e.g., transmits) two PRS resource sets, labeled “PRS Resource Set 1” and “PRS Resource Set 2,” and the second TRP (“TRP2”) is associated with one PRS resource set, labeled “PRS Resource Set 3.” Each PRS resource set comprises at least two PRS resources. Specifically, the first PRS resource set (“PRS Resource Set 1”) includes PRS resources labeled “PRS Resource 1” and “PRS Resource 2.” the second PRS resource set (“PRS Resource Set 2”) includes PRS resources labeled “PRS Resource 3” and “PRS Resource 4,” and the third PRS resource set (“PRS Resource Set 3”) includes PRS resources labeled “PRS Resource 5” and “PRS Resource 6.”

Referring to FIG. 9, when a UE is configured in the assistance data of a positioning method with a number of PRS resources beyond its capability, the UE assumes the DL-PRS Resources in the assistance data are sorted in a decreasing order of measurement priority. In some designs, 4 frequency layers are sorted according to priority, 64 TRPs per frequency layer are sorted according to priority, and 2 sets per TRP of the frequency layer are sorted according to priority. In some designs, 64 resources of the set per TRP per frequency layer are sorted according to priority. In some designs, the reference indicated by nr-DL-PRS-ReferenceInfo-r16 for each frequency layer has the highest priority at least for DL-TDOA.

In some designs, for DL-AoD, one of the following options for reporting of RSRP measurements per TRP, e.g.:
Option 1: Up to 8 measurements in a measurement report (as in 3GGP Rel. 16),
Option 2: Up to 8 measurements in a measurement report, for the same Rx beam index, or
Option 3: Up to N>=8 measurements.

In some designs, multiple measurements corresponding to different Rx Beam index may be reported for a given PRS resource.

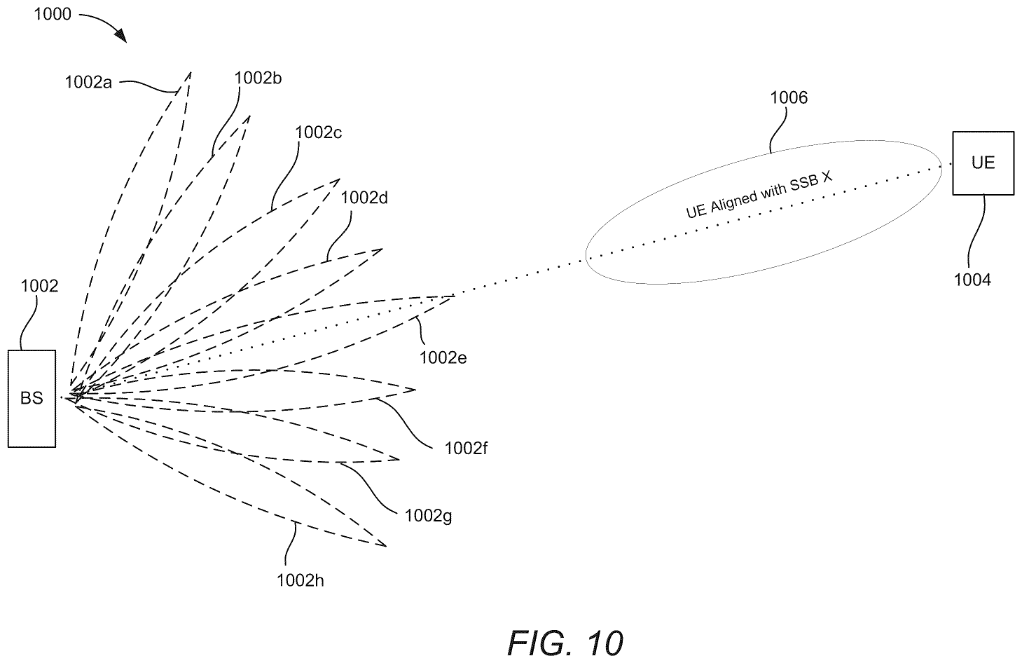

FIG. 10 illustrates a parent beam configuration 1000 in accordance with an aspect of the disclosure. In FIG. 10, BS 1002 may perform beam sweeping (e.g., SSB transmission) on 8 parent transmit beams 1002a through 1002h (e.g., parent PRS transmit beams). In context, the transmit beams 1002a and 1002h are “parent” transmit beams because these transmit beams are not children (or do not fall inside) the beamwidth of another transmit beam. While not shown explicitly in FIG. 10, some or all of the parent transmit beams 1002a through 1002h may be associated with child transmit beams (e.g., one or more transmit beams with a beamwidth that falls inside of the transmit beamwidth of a respective parent transmit beam). In FIG. 10, UE 1004 has a receive beam 1006 that is aligned best with an SSB (“SSB X”) associated with parent transmit beam 1002e.

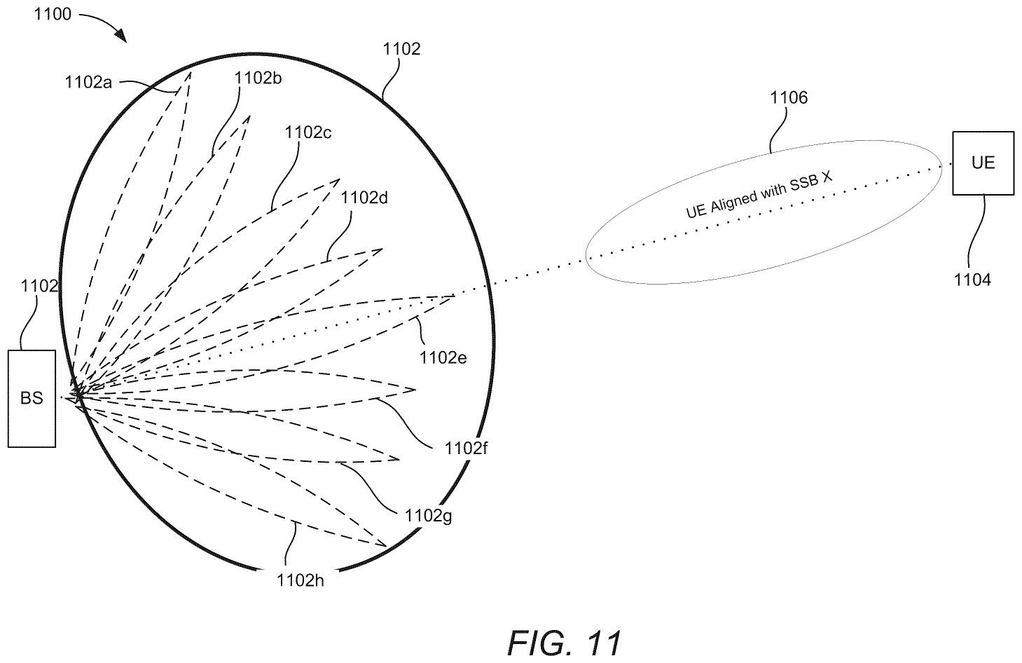

FIG. 11 illustrates a child beam configuration 1100 in accordance with an aspect of the disclosure. In FIG. 11, a parent beam 1102 is associated with 8 child transmit beams 1102a through 1102h (e.g., child PRS transmit beams). BS 1102 may perform beam sweeping (e.g., SSB transmission) on child transmit beams 1102a through 1102h. In context, the transmit beams 1102a and 1102h are “child” transmit beams because these transmit beams are children (or fall inside) the beamwidth of the parent beam 1102. In FIG. 11, UE 1104 has a receive beam 1106 that is aligned best with an SSB (“SSB X”) associated with child transmit beam 1102e.

Referring to FIGS. 10-11, it will be appreciated that the respective beamwidths of the parent beams and child beams are depicted for illustrative purposes and are not to scale. So, the parent beam which includes the child beams depicted in FIG. 11 may be representative of any of the parent beams depicted in FIG. 10, as an example.

In some designs, to determine the best beam pair for positioning, a base station may first beam sweep across a set of 8 parent transmit beams to identify the best parent transmit beam. Then, the base station may beam sweep across a set of 8 child transmit beams associated with the identified best parent transmit beam to identify the best respective child transmit beam. Then, the identified best respective child transmit beam may be selected for transmission of PRS to the UE for a position estimation procedure.

Aspects of the disclosure are directed to configuration of child PRS resource set configuration(s) before measurements of parent beam(s) are performed. In some designs, this may permit the UE to measure the parent beam(s), identify the best parent beam(s), and then monitor the corresponding child beam(s) with less overhead (e.g., because the child beam(s) have already been configured). Such aspects may provide various technical advantages, such as reduced position estimation latency and/or precision for scenarios where child PRS beams are used in conjunction with parent PRS beams.

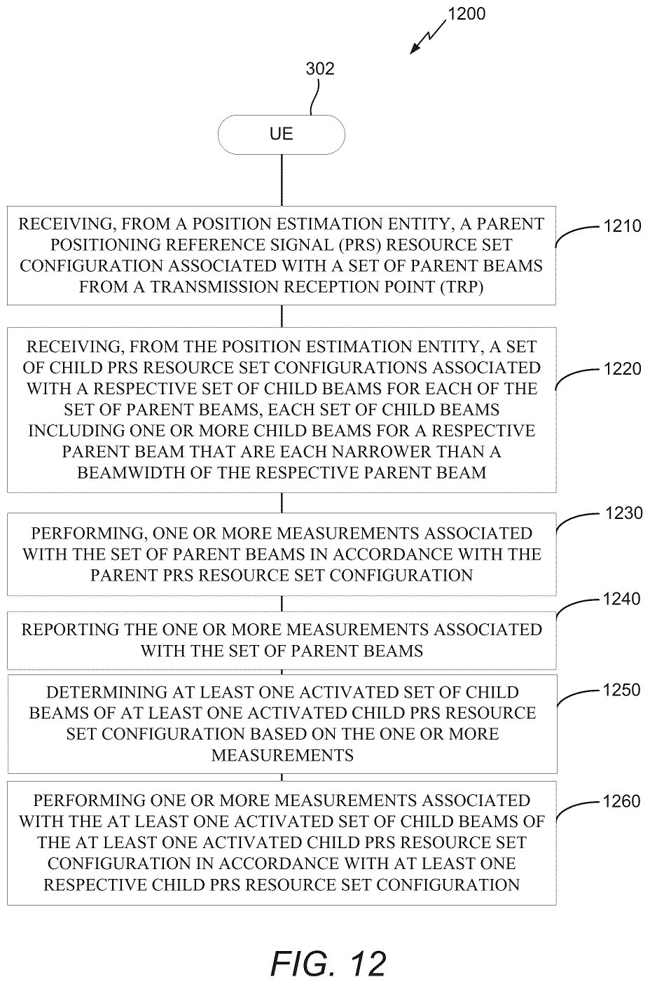

FIG. 12 illustrates an exemplary process 1200 of wireless communication, according to aspects of the disclosure. In an aspect, the process 1200 may be performed by a UE (e.g., a UE for which position estimation is desired), such as UE 302.

Referring to FIG. 12, at 1210, UE 302 (e.g., receiver 312 or 322, data bus 334, etc.) receives, from a position estimation entity, a parent positioning reference signal (PRS) resource set configuration associated with a set of parent beams from a transmission reception point (TRP). In some designs, the position estimation entity may correspond to the UE itself (e.g., for UE-based position estimation) or BS 304 (e.g., LMF integrated in RAN) or network entity 306 (e.g., LMF integrated in core network component, a location server, etc.). In case of UE-based position estimation, the reception of 1210 corresponds to an internal transfer of data between logical components. A means for performing the reception of 1210 may include receiver 312 or 322, data bus 334, etc., of UE 302.

Referring to FIG. 12, at 1220, UE 302 (e.g., receiver 312 or 322, data bus 334 etc.) receives, from the position estimation entity, a set of child PRS resource set configurations associated with a respective set of child beams for each of the set of parent beams, each set of child beams including one or more child beams for a respective parent beam that are each narrower than a beamwidth of the respective parent beam. In some designs, the position estimation entity may correspond to the UE itself (e.g., for UE-based position estimation) or BS 304 (e.g., LMF integrated in RAN) or network entity 306 (e.g., LMF integrated in core network component, a location server, etc.). In case of UE-based position estimation, the reception of 1220 corresponds to an internal transfer of data between logical components. A means for performing the reception of 1220 may include receiver 312 or 322, data bus 334, etc., of UE 302.

Referring to FIG. 12, at 1230. UE 302 (e.g., receiver 312 or 322, PRS module 342, processor(s) 332, etc.) performs one or more measurements associated with the set of parent beams in accordance with the parent PRS resource set configuration. In some designs, the measurement(s) of the parent beams at 1230 may be used to determine which child PRS resource set(s) and/or child beam(s) are to be activated. A means for performing the measurements of 1230 may include receiver 312 or 322, PRS module 342, processor(s) 332, etc., of UE 302.

Referring to FIG. 12, at 1240. UE 302 (e.g., transmitter 314 or 324. PRS module 342, processor(s) 332, data bus 334, etc.) reports the one or more measurements associated with the set of parent beams. For example, the one or more measurements may be reported to a position estimation entity, which may then selectively activate particular child beam(s) and/or child PRS resource set(s) based on the reporting. A means for performing the reporting of 1240 may include transmitter 314 or 324, PRS module 342, processor(s) 332, data bus 334, etc., of UE 302.

Referring to FIG. 12, at 1250, UE 302 (e.g., PRS module 342, processor(s) 332, etc.) determines at least one activated set of child beams of at least one activated child PRS resource set configuration based on the one or more measurements. In some designs, the determination at 1250 may be based on decision logic executed at UE 302 itself (e.g., UE 302 evaluates the parent beam measurements to determine which child beam(s) to be activated). In other designs, UE 302 may receive an instruction from the position estimation entity responsive to the reporting that indicates which child beam(s) to be activated (e.g., child PRS resource set(s) or individual child beam(s) within a child PRS resource set). A means for performing the determination of 1250 may include receiver 312 or 322. PRS module 342, processor(s) 332, etc., of UE 302.

Referring to FIG. 12, at 1260, UE 302 (e.g., receiver 312 or 322, PRS module 342, processor(s) 332, etc.) performs one or more measurements associated with the at least one activated set of child beams of the at least one activated child PRS resource set configuration in accordance with at least one respective child PRS resource set configuration. For example, the child beam(s) activated and measured at 1260 may be based on the best or N best parent beams (e.g., in terms of RSRP and/or other performance metrics) from 1230. A means for performing the measurements of 1260 may include receiver 312 or 322, PRS module 342, processor(s) 332, etc., of UE 302.

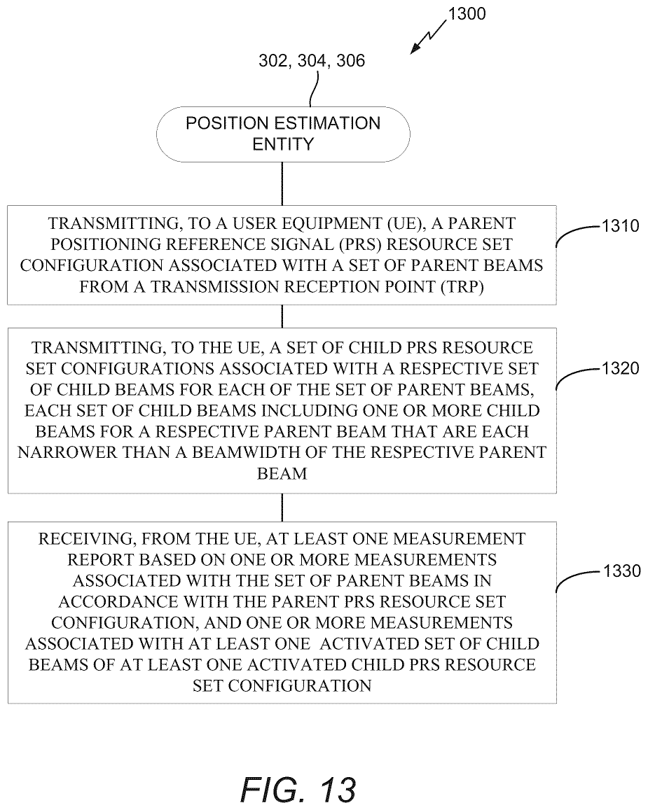

FIG. 13 illustrates an exemplary process 1300 of wireless communication, according to aspects of the disclosure. In an aspect, the process 1300 may be performed by a position estimation entity. In some designs, the position estimation entity may correspond to UE 302 (e.g., for UE-based position estimation) or BS 304 (e.g., LMF integrated in RAN) or network entity 306 (e.g., LMF integrated in core network component, a location server, etc.).

Referring to FIG. 13, at 1310, the position estimation entity (e.g., transmitter 314 or 324 or 354 or 364, network transceiver(s) 390, data bus 334 or 382 or 392, etc.) transmits, to a user equipment (UE), a parent positioning reference signal (PRS) resource set configuration associated with a set of parent beams from a transmission reception point (TRP). In case of UE-based position estimation, the transmission of 1310 corresponds to an internal transfer of data between logical components. A means for performing the transmission of 1310 may include transmitter 314 or 324 or 354 or 364, network transceiver(s) 380 or 390, data bus 334 or 382 or 392, of UE 302 or BS 304 or network entity 306.

Referring to FIG. 13, at 1320, the position estimation entity (e.g., transmitter 314 or 324 or 354 or 364, network transceiver(s) 390, data bus 334 or 382 or 392, etc.) transmits, to the UE, a set of child PRS resource set configurations associated with a respective set of child beams for each of the set of parent beams, each set of child beams including one or more child beams for a respective parent beam that are each narrower than a beamwidth of the respective parent beam. In case of UE-based position estimation, the transmission of 1320 corresponds to an internal transfer of data between logical components. A means for performing the transmission of 1320 may include transmitter 314 or 324 or 354 or 364, network transceiver(s) 380 or 390, data bus 334 or 382 or 392, of UE 302 or BS 304 or network entity 306.

Referring to FIG. 13, at 1330, the position estimation entity (e.g., receiver 312 or 322 or 352 or 362, network transceiver(s) 380 or 390, data bus 334 or 382 or 392, etc.) receives, from the UE, at least one measurement report based on one or more measurements associated with the set of parent beams in accordance with the parent PRS resource set configuration, and one or more measurements associated with at least one activated set of child beams of at least one activated child PRS resource set configuration. In case of UE-based position estimation, the transmission of 1330 corresponds to an internal transfer of data between logical components. A means for performing the reception of 1330 may include receiver 312 or 322 or 352 or 362, network transceiver(s) 380 or 390, data bus 334 or 382 or 392, of UE 302 or BS 304 or network entity 306.

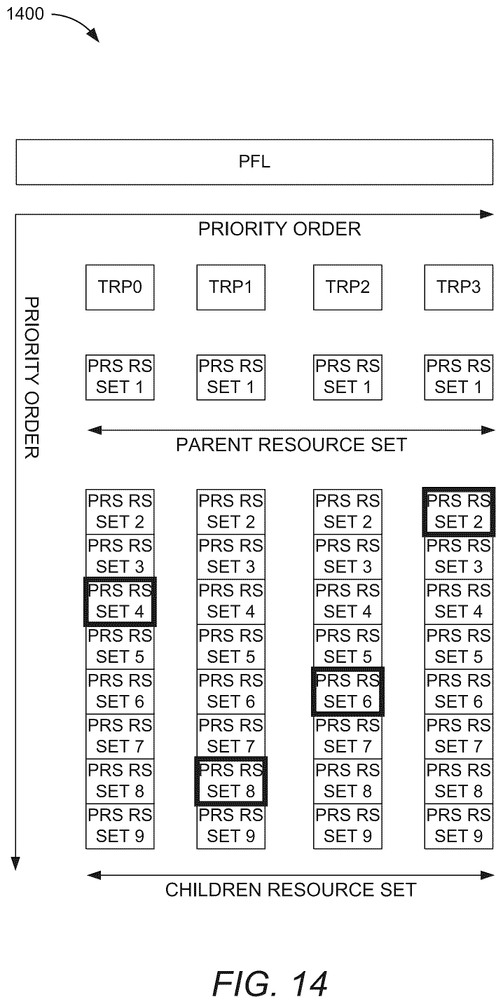

Referring to FIGS. 12-13, in some designs, the set of child PRS resource set configurations includes a plurality of child PRS resource set configurations, and each of the plurality of child PRS resource set configurations is associated with a different parent beam among the set of parent beams. In some designs, only one of the set of child PRS resource set configurations is activated for the one or more measurements of the child beam(s), as shown in FIG. 14.

FIG. 14 illustrates an example implementation 1400 of the processes 1200-1300 of FIGS. 12-13, respectively, in accordance with aspects of the disclosure. In FIG. 14, assume that there is a maximum of two PRS resource set activated per TRP at given time (e.g., in other designs, this maximum may be different). The position estimation entity may thereby configure 1+8=9 PRS recourse set per TRP. In FIG. 14, PRS resource sets (PRS RS sets 1 . . . 9) within the same positioning frequency layer (PFL) are shown for each of TRP0, TRP1, TRP2 and TRP3. For each of TRP0. TRP1, TRP2 and TRP3, PRS RS set 1 carries PRS for the parent beams (e.g., up to 8 parent beams). Each of PRS RS sets 2 . . . 9 are configured and are each associated with a child beam (e.g., up to 8 child beams). In particular, PRS RS set 1 is default resource set for the parent PRS beams. Among the child PRS resource sets, only one PRS resource set activated any given time. In some designs, different child PRS recourse set can have different number of PRS beams (e.g., 2, 4, 6, 8, etc.). In some designs, each child beam may be finer (less beamwidth) than a corresponding wider parent beam.

Referring to FIG. 14, in some designs, the default child PRS resource set can be activated in the assistance data (AD). In some designs, any change in the child PRS resource set can be signal through lower lavers (e.g., MAC CE, DCI, RRC configurations). In some designs, any such activation changes with respect to the child PRS resource set can be based upon wider/parent beam reporting. In some designs, for an on-demand framework gNB only need to transmit activated child PRS resource set at given time (e.g., to reduce overhead, etc.).

Referring to FIG. 14, for each of TRP0, TRP2, TRP3 and TRP4, the UE measures PRS RS set 1 to determine the best parent beam, and then activates the PRS RS set for the child beam corresponding to the best parent beam. In FIG. 14, assume that PRS RS set 1 for TRP0 results in PRS RS set 4 being activated for measurement of a respective child beam from TRP0, PRS RS set 1 for TRP1 results in PRS RS set 8 being activated for measurement of a respective child beam from TRP1, PRS RS set 1 for TRP2 results in PRS RS set 6 being activated for measurement of a respective child beam from TRP2, and PRS RS set 1 for TRP3 results in PRS RS set 2 being activated for measurement of a respective child beam from TRP3.

Referring to FIG. 14, as noted above, the activated child PRS resource set configuration may be based on the one or more measurements of the set of parent beams (e.g., identify best parent beam in terms of RSRP and/or other metrics, and then activate the child PRS resource set for the identified best parent beam if that child PRS resource set is not already activated as the default child PRS resource set). In some designs as noted above, a default child PRS resource set is designated via AD. In this case, the activated child PRS resource set configuration corresponds to the default child PRS resource set or is modified from the default child PRS resource set (e.g., via lower layer signaling) based on the one or more measurements of the set of parent beams.

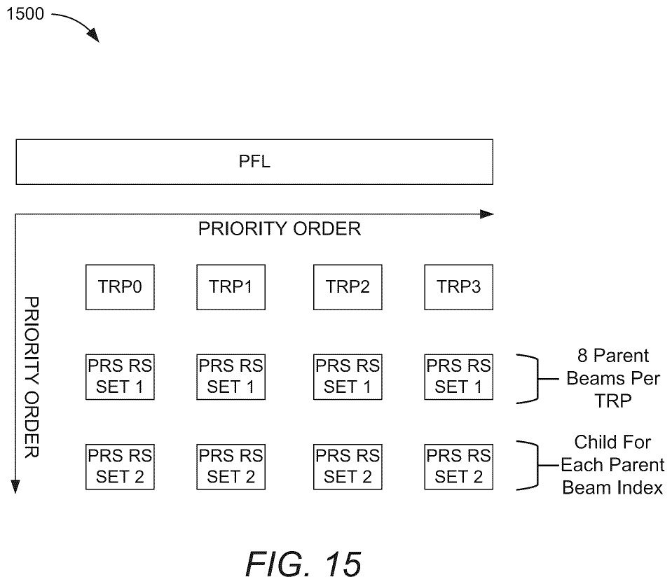

Referring to FIGS. 12-13, in some designs, the set of child PRS resource set configurations includes a single child PRS resource set configuration, and the single child PRS resource set configuration includes the respective activated set of child beams for each of the set of parent beams, as shown in FIG. 15.

FIG. 15 illustrates an example implementation 1500 of the processes 1200-1300 of FIGS. 12-13, respectively, in accordance with aspects of the disclosure. In FIG. 15, assume that there is a maximum of two PRS resource set activated per TRP at given time (e.g., in other designs, this maximum may be different). The position estimation entity may thereby configure two PRS resource set, PRS resource set 1 for the parent beams (e.g., parent resource set will have 8 beam to measure, which are representative of the wider beams), and PRS resource set 2 for children beams (e.g., the children beams of all parent beams, whereby each parent beam may be associated with the same or different number of child beams). In some designs, the position estimation entity (e.g., LMF, etc.) may provide an association between child beam(s) and parent beam(s). In some designs, the association is implemented via PRS QCL information (e.g., already specified in existing or legacy standards). In some designs, the association may include boresight and/or beamwidth information. In some designs, all PRS resources within the child PRS resource set are within the X-dB beamwidth of their respective parent beam in the parent PRS resource set. In some designs, all PRS resources within the child set are within the X degrees of the boresight direction of their respective parent beam in the parent PRS resource set. In some designs, for each of TRP0, TRP1, TRP2 and TRP3, UE measures PRS RS set 1 to identify the best parent beam(s) (e.g., in terms of RSRP, etc.), and searches the child beam(s) in PRS RS set 2 corresponding to the best parent beam. In some designs, the position estimation entity (e.g., LMF, etc.) can ask UE to measure child correspond to few best parent beams (e.g., N best parent beams). In FIG. 15, gNB may need to transmit all the child beam all the time (e.g., in contrast to FIG. 14 where some of the non-activated PRS RS sets may be turned off or not transmitted upon).

Referring to FIG. 15, in some designs as noted above, the UE may determine, for each parent beam among the set of parent beams, an association between its respective set of child beams. As noted above, the association may include a beamwidth threshold, a boresight direction threshold, or a combination thereof. In some designs, the at least one set of child beams includes a single set of child beams associated with a best parent beam in terms of one or more performance metrics based on the one or more measurements of the set of parent beams. In other designs, the at least one set of child beams includes multiple sets of child beams associated with N parent beams in terms of one or more performance metrics based on the one or more measurements of the set of parent beams.

Referring to FIGS. 12-13, the one or more measurements of the set of parent beams and the one or more measurements of the at least one activated set of child beams are performed during the same measurement period. For example, a measurement period may be defined for the UE to perform measurements (e.g., RSRP DL-AoD, TOA, etc.) on parent and child resource set(s). For example, if the UE is required to provide measurements that are derived using the child beam after the parent beam is measured, the measurement period may account for the reception of both. In a further example, the UE may perform full beam sweeping for the parent set (N_rxbeams=8) in the measurement period formulation, but for child set (N_rxbeams=1).

Referring to FIGS. 12-13, the set of parent beams and the at least one activated set of child beams are associated with the same frequency layer, or the set of parent beams is associated with a first frequency layer of a bandwidth of a frequency range and the at least one activated set of child beams is associated with a second frequency layer of the bandwidth of the frequency range, or the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Referring to FIGS. 12-13, in some designs, the UE may transmit to the position estimation entity an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

Referring to FIGS. 12-13, in some designs, each child beam is associated with a narrower beamwidth than its respective parent beam. In some designs, the UE may use the wider beam for a “quick scan” purpose (e.g., the parent beam can be reported to facilitate a coarse location estimation, while the final positioning estimate at location server will be based on the finer beams).

Referring to FIGS. 12-13, in some designs, the set of parent beams are transmitted by the TRP at a first periodicity, and one or more (e.g., all child beams, or less than all child beams because as noted above in FIG. 14 not all of the child resource sets need be transmitted or activated for on-demand scenario) of the activated set(s) of child beams are transmitted (or activated) by the TRP at a second periodicity that is shorter than the first periodicity. For example, the wider (e.g., parent) beams may be transmitted at a periodicity of 160*8 msec, and the finer (e.g., child) beams may be transmitted (or activated) at a periodicity of 160 msec.

Referring to FIGS. 12-13, in some designs, the UE may transmit at least one measurement report based on the one or more measurement associated with the set of parent beams the one or more measurements associated with the at least one set of child beams. In some designs, separate measurement reports may be used for at least some of the reporting (e.g., because the wider parent beams may transmit PRS less frequently than the finer child beams).

Referring to FIGS. 12-13, in some designs as noted above, the position estimation entity (e.g., LMF, etc.) may signal the UE to measure (or activate) the child beam(s) for the best parent beam or the best N parent beams. In some designs, a given child beam is included in respective sets of child beams for two or more respective parent beams. In such a case, the respective child beam PRS resources may be activated for the multiple parent beams via some sequence (e.g., a round-robin technique).

Referring to FIGS. 12-13, in some designs, the same child beam PRS resources may be activated for multiple parent beams. For example, a particular narrow beam (e.g., child beam) may be within X-dB and/or X-degrees of more than one parent beam, in other words, this narrow beam can be configured as the child of more than one parent.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of operating a user equipment (UE), comprising: receiving, from a position estimation entity, a parent positioning reference signal (PRS) resource set configuration associated with a set of parent beams from a transmission reception point (TRP): receiving, from the position estimation entity, a set of child PRS resource set configurations associated with a respective set of child beams for each of the set of parent beams, each set of child beams including one or more child beams for a respective parent beam that are each narrower than a beamwidth of the respective parent beam: performing, one or more measurements associated with the set of parent beams in accordance with the parent PRS resource set configuration: reporting the one or more measurements associated with the set of parent beams; and determining at least one activated set of child beams of at least one activated child PRS resource set configuration based on the one or more measurements; and performing one or more measurements associated with the at least one activated set of child beams of the at least one activated child PRS resource set configuration in accordance with at least one respective child PRS resource set configuration.

Clause 2. The method of clause 1, wherein the set of child PRS resource set configurations includes a plurality of child PRS resource set configurations, and wherein each of the plurality of child PRS resource set configurations is associated with a different parent beam among the set of parent beams.

Clause 3. The method of clause 2, wherein a default child PRS resource set is designated via assistance data (AD), and wherein the at least one activated child PRS resource set configuration corresponds to the default child PRS resource set or is modified from the default child PRS resource set configuration based on the one or more measurements of the set of parent beams.

Clause 4. The method of any of clauses 1 to 3, wherein the set of child PRS resource set configurations includes a single child PRS resource set configuration, and wherein the single child PRS resource set configuration includes the respective set of child beams for each of the set of parent beams.

Clause 5. The method of clause 4, further comprising: determining, for each parent beam among the set of parent beams, an association between its respective set of child beams.

Clause 6. The method of clause 5, wherein the association comprises a beamwidth threshold, a boresight direction threshold, or a combination thereof.

Clause 7. The method of any of clauses 1 to 6, wherein the at least one activated set of child beams includes a single activated set of child beams associated with a best parent beam in terms of one or more performance metrics based on the one or more measurements associated with the set of parent beams.

Clause 8. The method of any of clauses 1 to 7, wherein the at least one activated set of child beams includes multiple activated sets of child beams associated with N best parent beams in terms of one or more performance metrics based on the one or more measurements associated with the set of parent beams.

Clause 9. The method of any of clauses 1 to 8, wherein the one or more measurements associated with the set of parent beams and the one or more measurements associated with the at least one activated set of child beams are performed during the same measurement period.

Clause 10. The method of any of clauses 1 to 9, wherein the set of parent beams and the at least one activated set of child beams are associated with the same frequency layer, or wherein the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Clause 11. The method of any of clauses 1 to 10, further comprising: transmitting, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

Clause 12. The method of any of clauses 1 to 11, wherein each child beam is associated with a narrower beamwidth than its respective parent beam.

Clause 13. The method of any of clauses 1 to 12, wherein the set of parent beams is transmitted by the TRP at a first periodicity, and wherein one or more of the sets of child beams are transmitted by the TRP at a second periodicity that is shorter than the first periodicity.

Clause 14. The method of any of clauses 1 to 13, wherein a given child beam is included in respective sets of child beams for two or more respective parent beams.

Clause 15. A method of operating a position estimation entity, comprising: transmitting, to a user equipment (UE), a parent positioning reference signal (PRS) resource set configuration associated with a set of parent beams from a transmission reception point (TRP): transmitting, to the UE, a set of child PRS resource set configurations associated with a respective set of child beams for each of the set of parent beams, each set of child beams including one or more child beams for a respective parent beam that are each narrower than a beamwidth of the respective parent beam; and receiving, from the UE, at least one measurement report based on one or more measurements associated with the set of parent beams in accordance with the parent PRS resource set configuration, and one or more measurements associated with at least one activated set of child beams of at least one activated child PRS resource set configuration.

Clause 16. The method of clause 15, wherein the set of child PRS resource set configurations includes a plurality of child PRS resource set configurations, and wherein each of the plurality of child PRS resource set configurations is associated with a different parent beam among the set of parent beams.

Clause 17. The method of any of clauses 15 to 16, wherein the set of child PRS resource set configurations includes a single child PRS resource set configuration, and wherein the single child PRS resource set configuration includes the respective set of child beams for each of the set of parent beams.

Clause 18. The method of any of clauses 15 to 17, wherein the at least one activated set of child beams includes a single set of child beams associated with a best parent beam in terms of one or more performance metrics based on the one or more measurements associated with the set of parent beams.

Clause 19. The method of any of clauses 15 to 18, wherein the at least one activated set of child beams includes multiple activated sets of child beams associated with N best parent beams in terms of one or more performance metrics based on the one or more measurements of the set of parent beams.

Clause 20. The method of any of clauses 18 to 19, wherein the one or more measurements associated with the set of parent beams and the one or more measurements associated with the at least one activated set of child beams are performed during the same measurement period.

Clause 21. The method of any of clauses 18 to 20, wherein the set of parent beams and the at least one activated set of child beams are associated with the same frequency layer, or wherein the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Clause 22. The method of any of clauses 15 to 21, further comprising: receiving, from the UE, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

Clause 23. The method of any of clauses 15 to 22, wherein each child beam is associated with a narrower beamwidth than its respective parent beam.

Clause 24. The method of any of clauses 15 to 23, wherein the at least one measurement report comprises multiple measurement reports.

Clause 25. A user equipment (UE), comprising: a memory: at least one transceiver; and at least one processor communicatively coupled to the memory and the at least one transceiver, the at least one processor configured to: receive, via the at least one transceiver, from a position estimation entity, a parent positioning reference signal (PRS) resource set configuration associated with a set of parent beams from a transmission reception point (TRP); receive, via the at least one transceiver, from the position estimation entity, a set of child PRS resource set configurations associated with a respective set of child beams for each of the set of parent beams, each set of child beams including one or more child beams for a respective parent beam that are each narrower than a beamwidth of the respective parent beam; perform, one or more measurements associated with the set of parent beams in accordance with the parent PRS resource set configuration; report the one or more measurements associated with the set of parent beams; and determine at least one activated set of child beams of at least one activated child PRS resource set configuration based on the one or more measurements; and perform one or more measurements associated with the at least one activated set of child beams of the at least one activated child PRS resource set configuration in accordance with at least one respective child PRS resource set configuration.

Clause 26. The UE of clause 25, wherein the set of child PRS resource set configurations includes a plurality of child PRS resource set configurations, and wherein each of the plurality of child PRS resource set configurations is associated with a different parent beam among the set of parent beams.

Clause 27. The UE of clause 26, wherein a default child PRS resource set is designated via assistance data (AD), and wherein the at least one activated child PRS resource set configuration corresponds to the default child PRS resource set or is modified from the default child PRS resource set configuration based on the one or more measurements of the set of parent beams.

Clause 28. The UE of any of clauses 25 to 27, wherein the set of child PRS resource set configurations includes a single child PRS resource set configuration, and wherein the single child PRS resource set configuration includes the respective set of child beams for each of the set of parent beams.

Clause 29. The UE of clause 28, wherein the at least one processor is further configured to: determine, for each parent beam among the set of parent beams, an association between its respective set of child beams.

Clause 30. The UE of clause 29, wherein the association comprises a beamwidth threshold, a boresight direction threshold, or a combination thereof.

Clause 31. The UE of any of clauses 25 to 30, wherein the at least one activated set of child beams includes a single activated set of child beams associated with a best parent beam in terms of one or more performance metrics based on the one or more measurements associated with the set of parent beams.

Clause 32. The UE of any of clauses 25 to 31, wherein the at least one activated set of child beams includes multiple activated sets of child beams associated with N best parent beams in terms of one or more performance metrics based on the one or more measurements associated with the set of parent beams.

Clause 33. The UE of any of clauses 25 to 32, wherein the one or more measurements associated with the set of parent beams and the one or more measurements associated with the at least one activated set of child beams are performed during the same measurement period.

Clause 34. The UE of any of clauses 25 to 33, wherein the set of parent beams and the at least one activated set of child beams are associated with the same frequency laver, or wherein the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Clause 35. The UE of any of clauses 25 to 34, wherein the at least one processor is further configured to: transmit, via the at least one transceiver, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

Clause 36. The UE of any of clauses 25 to 35, wherein each child beam is associated with a narrower beamwidth than its respective parent beam.

Clause 37. The UE of any of clauses 25 to 36, wherein the set of parent beams is transmitted by the TRP at a first periodicity, and wherein one or more of the sets of child beams are transmitted by the TRP at a second periodicity that is shorter than the first periodicity.

Clause 38. The UE of any of clauses 25 to 37, wherein a given child beam is included in respective sets of child beams for two or more respective parent beams.

Clause 39. A position estimation entity, comprising: a memory; at least one transceiver; and at least one processor communicatively coupled to the memory and the at least one transceiver, the at least one processor configured to: transmit, via the at least one transceiver, to a user equipment (UE), a parent positioning reference signal (PRS) resource set configuration associated with a set of parent beams from a transmission reception point (TRP); transmit, via the at least one transceiver, to the UE, a set of child PRS resource set configurations associated with a respective set of child beams for each of the set of parent beams, each set of child beams including one or more child beams for a respective parent beam that are each narrower than a beamwidth of the respective parent beam; and receive, via the at least one transceiver, from the UE, at least one measurement report based on one or more measurements associated with the set of parent beams in accordance with the parent PRS resource set configuration, and one or more measurements associated with at least one activated set of child beams of at least one activated child PRS resource set configuration.

Clause 40. The position estimation entity of clause 39, wherein the set of child PRS resource set configurations includes a plurality of child PRS resource set configurations, and wherein each of the plurality of child PRS resource set configurations is associated with a different parent beam among the set of parent beams.

Clause 41. The position estimation entity of any of clauses 39 to 40, wherein the set of child PRS resource set configurations includes a single child PRS resource set configuration, and wherein the single child PRS resource set configuration includes the respective set of child beams for each of the set of parent beams.

Clause 42. The position estimation entity of any of clauses 39 to 41, wherein the at least one activated set of child beams includes a single set of child beams associated with a best parent beam in terms of one or more performance metrics based on the one or more measurements associated with the set of parent beams.

Clause 43. The position estimation entity of any of clauses 39 to 42, wherein the at least one activated set of child beams includes multiple activated sets of child beams associated with N best parent beams in terms of one or more performance metrics based on the one or more measurements of the set of parent beams.

Clause 44. The position estimation entity of any of clauses 42 to 43, wherein the one or more measurements associated with the set of parent beams and the one or more measurements associated with the at least one activated set of child beams are performed during the same measurement period.

Clause 45. The position estimation entity of any of clauses 42 to 44, wherein the set of parent beams and the at least one activated set of child beams are associated with the same frequency layer, or wherein the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Clause 46. The position estimation entity of any of clauses 39 to 45, wherein the at least one processor is further configured to: receive, via the at least one transceiver, from the UE, an indication of a capability of the UE to support a parent-to-child beam association between parent and child beams within the same frequency laver, within different frequency layers in the same bandwidth of a frequency range, within different frequency layers of different bandwidths of different frequency ranges, or a combination thereof.

Clause 47. The position estimation entity of any of clauses 39 to 46, wherein each child beam is associated with a narrower beamwidth than its respective parent beam.

Clause 48. The position estimation entity of any of clauses 39 to 47, wherein the at least one measurement report comprises multiple measurement reports.

Clause 49. A user equipment (UE), comprising: means for receiving, from a position estimation entity, a parent positioning reference signal (PRS) resource set configuration associated with a set of parent beams from a transmission reception point (TRP); means for receiving, from the position estimation entity, a set of child PRS resource set configurations associated with a respective set of child beams for each of the set of parent beams, each set of child beams including one or more child beams for a respective parent beam that are each narrower than a beamwidth of the respective parent beam: means for performing, one or more measurements associated with the set of parent beams in accordance with the parent PRS resource set configuration; means for reporting the one or more measurements associated with the set of parent beams, and means for determining at least one activated set of child beams of at least one activated child PRS resource set configuration based on the one or more measurements; and means for performing one or more measurements associated with the at least one activated set of child beams of the at least one activated child PRS resource set configuration in accordance with at least one respective child PRS resource set configuration.

Clause 50. The UE of clause 49, wherein the set of child PRS resource set configurations includes a plurality of child PRS resource set configurations, and wherein each of the plurality of child PRS resource set configurations is associated with a different parent beam among the set of parent beams.

Clause 51. The UE of clause 50, wherein a default child PRS resource set is designated via assistance data (AD), and wherein the at least one activated child PRS resource set configuration corresponds to the default child PRS resource set or is modified from the default child PRS resource set configuration based on the one or more measurements of the set of parent beams.

Clause 52. The UE of any of clauses 49 to 51, wherein the set of child PRS resource set configurations includes a single child PRS resource set configuration, and wherein the single child PRS resource set configuration includes the respective set of child beams for each of the set of parent beams.

Clause 53. The UE of clause 52, further comprising: means for determining, for each parent beam among the set of parent beams, an association between its respective set of child beams.

Clause 54. The UE of clause 53, wherein the association comprises a beamwidth threshold, a boresight direction threshold, or a combination thereof.

Clause 55. The UE of any of clauses 49 to 54, wherein the at least one activated set of child beams includes a single activated set of child beams associated with a best parent beam in terms of one or more performance metrics based on the one or more measurements associated with the set of parent beams.

Clause 56. The UE of any of clauses 49 to 55, wherein the at least one activated set of child beams includes multiple activated sets of child beams associated with N best parent beams in terms of one or more performance metrics based on the one or more measurements associated with the set of parent beams.

Clause 57. The UE of any of clauses 49 to 56, wherein the one or more measurements associated with the set of parent beams and the one or more measurements associated with the at least one activated set of child beams are performed during the same measurement period.

Clause 58. The UE of any of clauses 49 to 57, wherein the set of parent beams and the at least one activated set of child beams are associated with the same frequency layer, or wherein the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Clause 59. The UE of any of clauses 49 to 58, further comprising: means for transmitting, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

Clause 60. The UE of any of clauses 49 to 59, wherein each child beam is associated with a narrower beamwidth than its respective parent beam.

Clause 61. The UE of any of clauses 49 to 60, wherein the set of parent beams is transmitted by the TRP at a first periodicity, and wherein one or more of the sets of child beams are transmitted by the TRP at a second periodicity that is shorter than the first periodicity.

Clause 62. The UE of any of clauses 49 to 61, wherein a given child beam is included in respective sets of child beams for two or more respective parent beams.

Clause 63. A position estimation entity, comprising: means for transmitting, to a user equipment (UE), a parent positioning reference signal (PRS) resource set configuration associated with a set of parent beams from a transmission reception point (TRP): means for transmitting, to the UE, a set of child PRS resource set configurations associated with a respective set of child beams for each of the set of parent beams, each set of child beams including one or more child beams for a respective parent beam that are each narrower than a beamwidth of the respective parent beam; and means for receiving, from the UE, at least one measurement report based on one or more measurements associated with the set of parent beams in accordance with the parent PRS resource set configuration, and one or more measurements associated with at least one activated set of child beams of at least one activated child PRS resource set configuration.

Clause 64. The position estimation entity of clause 63, wherein the set of child PRS resource set configurations includes a plurality of child PRS resource set configurations, and wherein each of the plurality of child PRS resource set configurations is associated with a different parent beam among the set of parent beams.

Clause 65. The position estimation entity of any of clauses 63 to 64, wherein the set of child PRS resource set configurations includes a single child PRS resource set configuration, and wherein the single child PRS resource set configuration includes the respective set of child beams for each of the set of parent beams.

Clause 66. The position estimation entity of any of clauses 63 to 65, wherein the at least one activated set of child beams includes a single set of child beams associated with a best parent beam in terms of one or more performance metrics based on the one or more measurements associated with the set of parent beams.

Clause 67. The position estimation entity of any of clauses 63 to 66, wherein the at least one activated set of child beams includes multiple activated sets of child beams associated with N best parent beams in terms of one or more performance metrics based on the one or more measurements of the set of parent beams.

Clause 68. The position estimation entity of any of clauses 66 to 67, wherein the one or more measurements associated with the set of parent beams and the one or more measurements associated with the at least one activated set of child beams are performed during the same measurement period.

Clause 69. The position estimation entity of any of clauses 66 to 68, wherein the set of parent beams and the at least one activated set of child beams are associated with the same frequency layer, or wherein the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Clause 70. The position estimation entity of any of clauses 63 to 69, further comprising: means for receiving, from the UE, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

Clause 71. The position estimation entity of any of clauses 63 to 70, wherein each child beam is associated with a narrower beamwidth than its respective parent beam.

Clause 72. The position estimation entity of any of clauses 63 to 71, wherein the at least one measurement report comprises multiple measurement reports.

Clause 73. A non-transitory computer-readable medium storing computer-executable instructions that, when executed by a user equipment (UE), cause the UE to: receive, from a position estimation entity, a parent positioning reference signal (PRS) resource set configuration associated with a set of parent beams from a transmission reception point (TRP): receive, from the position estimation entity, a set of child PRS resource set configurations associated with a respective set of child beams for each of the set of parent beams, each set of child beams including one or more child beams for a respective parent beam that are each narrower than a beamwidth of the respective parent beam: perform, one or more measurements associated with the set of parent beams in accordance with the parent PRS resource set configuration: report the one or more measurements associated with the set of parent beams; and determine at least one activated set of child beams of at least one activated child PRS resource set configuration based on the one or more measurements; and perform one or more measurements associated with the at least one activated set of child beams of the at least one activated child PRS resource set configuration in accordance with at least one respective child PRS resource set configuration.

Clause 74. The non-transitory computer-readable medium of clause 73, wherein the set of child PRS resource set configurations includes a plurality of child PRS resource set configurations, and wherein each of the plurality of child PRS resource set configurations is associated with a different parent beam among the set of parent beams.

Clause 75. The non-transitory computer-readable medium of clause 74, wherein a default child PRS resource set is designated via assistance data (AD), and wherein the at least one activated child PRS resource set configuration corresponds to the default child PRS resource set or is modified from the default child PRS resource set configuration based on the one or more measurements of the set of parent beams.

Clause 76. The non-transitory computer-readable medium of any of clauses 73 to 75, wherein the set of child PRS resource set configurations includes a single child PRS resource set configuration, and wherein the single child PRS resource set configuration includes the respective set of child beams for each of the set of parent beams.

Clause 77. The non-transitory computer-readable medium of clause 76, further comprising instructions that, when executed by UE, further cause the UE to: determine, for each parent beam among the set of parent beams, an association between its respective set of child beams.

Clause 78. The non-transitory computer-readable medium of clause 77, wherein the association comprises a beamwidth threshold, a boresight direction threshold, or a combination thereof.

Clause 79. The non-transitory computer-readable medium of any of clauses 73 to 78, wherein the at least one activated set of child beams includes a single activated set of child beams associated with a best parent beam in terms of one or more performance metrics based on the one or more measurements associated with the set of parent beams.

Clause 80. The non-transitory computer-readable medium of any of clauses 73 to 79, wherein the at least one activated set of child beams includes multiple activated sets of child beams associated with N best parent beams in terms of one or more performance metrics based on the one or more measurements associated with the set of parent beams.

Clause 81. The non-transitory computer-readable medium of any of clauses 73 to 80, wherein the one or more measurements associated with the set of parent beams and the one or more measurements associated with the at least one activated set of child beams are performed during the same measurement period.

Clause 82. The non-transitory computer-readable medium of any of clauses 73 to 81, wherein the set of parent beams and the at least one activated set of child beams are associated with the same frequency layer, or wherein the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Clause 83. The non-transitory computer-readable medium of any of clauses 73 to 82, further comprising instructions that, when executed by UE, further cause the UE to: transmit, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

Clause 84. The non-transitory computer-readable medium of any of clauses 73 to 83, wherein each child beam is associated with a narrower beamwidth than its respective parent beam.

Clause 85. The non-transitory computer-readable medium of any of clauses 73 to 84, wherein the set of parent beams is transmitted by the TRP at a first periodicity, and wherein one or more of the sets of child beams are transmitted by the TRP at a second periodicity that is shorter than the first periodicity.

Clause 86. The non-transitory computer-readable medium of any of clauses 73 to 85, wherein a given child beam is included in respective sets of child beams for two or more respective parent beams.

Clause 87. A non-transitory computer-readable medium storing computer-executable instructions that, when executed by a position estimation entity, cause the position estimation entity to: transmit, to a user equipment (UE), a parent positioning reference signal (PRS) resource set configuration associated with a set of parent beams from a transmission reception point (TRP): transmit, to the UE, a set of child PRS resource set configurations associated with a respective set of child beams for each of the set of parent beams, each set of child beams including one or more child beams for a respective parent beam that are each narrower than a beamwidth of the respective parent beam; and receive, from the UE, at least one measurement report based on one or more measurements associated with the set of parent beams in accordance with the parent PRS resource set configuration, and one or more measurements associated with at least one activated set of child beams of at least one activated child PRS resource set configuration.

Clause 88. The non-transitory computer-readable medium of clause 87, wherein the set of child PRS resource set configurations includes a plurality of child PRS resource set configurations, and wherein each of the plurality of child PRS resource set configurations is associated with a different parent beam among the set of parent beams.

Clause 89. The non-transitory computer-readable medium of any of clauses 87 to 88, wherein the set of child PRS resource set configurations includes a single child PRS resource set configuration, and wherein the single child PRS resource set configuration includes the respective set of child beams for each of the set of parent beams.

Clause 90. The non-transitory computer-readable medium of any of clauses 87 to 89, wherein the at least one activated set of child beams includes a single set of child beams associated with a best parent beam in terms of one or more performance metrics based on the one or more measurements associated with the set of parent beams.

Clause 91. The non-transitory computer-readable medium of any of clauses 87 to 90, wherein the at least one activated set of child beams includes multiple activated sets of child beams associated with N best parent beams in terms of one or more performance metrics based on the one or more measurements of the set of parent beams.

Clause 92. The non-transitory computer-readable medium of any of clauses 90 to 91, wherein the one or more measurements associated with the set of parent beams and the one or more measurements associated with the at least one activated set of child beams are performed during the same measurement period.

Clause 93. The non-transitory computer-readable medium of any of clauses 90 to 92, wherein the set of parent beams and the at least one activated set of child beams are associated with the same frequency layer, or wherein the set of parent beams is associated with a first frequency layer of a bandwidth of a frequency range and the at least one activated set of child beams is associated with a second frequency layer of the bandwidth of the frequency range, or wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

Clause 94. The non-transitory computer-readable medium of any of clauses 87 to 93, further comprising instructions that, when executed by the position estimation entity, further cause the position estimation entity to receive, from the UE, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

Clause 95. The non-transitory computer-readable medium of any of clauses 87 to 94, wherein each child beam is associated with a narrower beamwidth than its respective parent beam

Clause 96. The non-transitory computer-readable medium of any of clauses 87 to 95, wherein the at least one measurement report comprises multiple measurement reports.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while dises reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

A complete listing of the claims, including current amendments (if any), is as follows:

1. A method of operating a user equipment (UE), comprising:
receiving, from a position estimation entity, a parent positioning reference signal (PRS) resource set configuration associated with a set of parent beams from a transmission reception point (TRP);
receiving, from the position estimation entity, a set of child PRS resource set configurations associated with a respective set of child beams for each of the set of parent beams, each set of child beams including one or more child beams for a respective parent beam that are each narrower than a beamwidth of the respective parent beam;
performing, one or more measurements associated with the set of parent beams in accordance with the parent PRS resource set configuration;
reporting the one or more measurements associated with the set of parent beams;
determining at least one activated set of child beams of at least one activated child PRS resource set configuration based on the one or more measurements; and
performing one or more measurements associated with the at least one activated set of child beams of the at least one activated child PRS resource set configuration in accordance with at least one respective child PRS resource set configuration.

2. The method of claim 1,
wherein the set of child PRS resource set configurations includes a plurality of child PRS resource set configurations, and
wherein each of the plurality of child PRS resource set configurations is associated with a different parent beam among the set of parent beams.

3. The method of claim 2,
wherein a default child PRS resource set is designated via assistance data (AD), and
wherein the at least one activated child PRS resource set configuration corresponds to the default child PRS resource set or is modified from the default child PRS resource set configuration based on the one or more measurements of the set of parent beams.

4. The method of claim 1,
wherein the set of child PRS resource set configurations includes a single child PRS resource set configuration, and
wherein the single child PRS resource set configuration includes the respective set of child beams for each of the set of parent beams.

5. The method of claim 4, further comprising:
determining, for each parent beam among the set of parent beams, an association between its respective set of child beams.

6. The method of claim 5, wherein the association comprises a beamwidth threshold, a boresight direction threshold, or a combination thereof.

7. The method of claim 1,
wherein the at least one activated set of child beams includes a single activated set of child beams associated with a best parent beam in terms of one or more performance metrics based on the one or more measurements associated with the set of parent beams, or
wherein the at least one activated set of child beams includes multiple activated sets of child beams associated with N best parent beams in terms of one or more performance metrics based on the one or more measurements associated with the set of parent beams, or
wherein the one or more measurements associated with the set of parent beams and the one or more measurements associated with the at least one activated set of child beams are performed during the same measurement period, or
wherein the set of parent beams and the at least one activated set of child beams are associated with the same frequency layer, or
wherein the set of parent beams is associated with a first frequency layer of a bandwidth of a frequency range and the at least one activated set of child beams is associated with a second frequency layer of the bandwidth of the frequency range, or
wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range, or
wherein a given child beam is included in respective sets of child beams for two or more respective parent beams, or
wherein each child beam is associated with a narrower beamwidth than its respective parent beam.

8. The method of claim 1, further comprising:
transmitting, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

9. The method of claim 1,
wherein the set of parent beams is transmitted by the TRP at a first periodicity, and
wherein one or more of the sets of child beams are transmitted by the TRP at a second periodicity that is shorter than the first periodicity.

10. A method of operating a position estimation entity, comprising:
transmitting, to a user equipment (UE), a parent positioning reference signal (PRS) resource set configuration associated with a set of parent beams from a transmission reception point (TRP);
transmitting, to the UE, a set of child PRS resource set configurations associated with a respective set of child beams for each of the set of parent beams, each set of child beams including one or more child beams for a respective parent beam that are each narrower than a beamwidth of the respective parent beam; and
receiving, from the UE, at least one measurement report based on one or more measurements associated with the set of parent beams in accordance with the parent PRS resource set configuration, and one or more measurements associated with at least one activated set of child beams of at least one activated child PRS resource set configuration.

11. The method of claim 10,
wherein the set of child PRS resource set configurations includes a plurality of child PRS resource set configurations, and each of the plurality of child PRS resource set configurations is associated with a different parent beam among the set of parent beams, or
wherein the set of child PRS resource set configurations includes a single child PRS resource set configuration, and the single child PRS resource set configuration includes the respective set of child beams for each of the set of parent beams, or
wherein the at least one activated set of child beams includes a single set of child beams associated with a best parent beam in terms of one or more performance metrics based on the one or more measurements associated with the set of parent beams.

12. The method of claim 10,
wherein the at least one activated set of child beams includes multiple activated sets of child beams associated with N best parent beams in terms of one or more performance metrics based on the one or more measurements of the set of parent beams, or
wherein the one or more measurements associated with the set of parent beams and the one or more measurements associated with the at least one activated set of child beams are performed during the same measurement period, or
wherein the set of parent beams and the at least one activated set of child beams are associated with the same frequency layer, or
wherein the set of parent beams is associated with a first frequency layer of a bandwidth of a frequency range and the at least one activated set of child beams is associated with a second frequency layer of the bandwidth of the frequency range, or
wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

13. The method of claim 10, further comprising:
receiving, from the UE, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

14. The method of claim 10, wherein each child beam is associated with a narrower beamwidth than its respective parent beam.

15. The method of claim 10, wherein the at least one measurement report comprises multiple measurement reports.

16. A user equipment (UE), comprising:
one or more memories;
one or more transceivers; and
one or more processors communicatively coupled to the one or more memories and the one or more transceivers, the one or more processors, either alone or in combination, configured to:
receive, via the one or more transceivers, from a position estimation entity, a parent positioning reference signal (PRS) resource set configuration associated with a set of parent beams from a transmission reception point (TRP);
receive, via the one or more transceivers, from the position estimation entity, a set of child PRS resource set configurations associated with a respective set of child beams for each of the set of parent beams, each set of child beams including one or more child beams for a respective parent beam that are each narrower than a beamwidth of the respective parent beam;
perform, one or more measurements associated with the set of parent beams in accordance with the parent PRS resource set configuration;
report the one or more measurements associated with the set of parent beams;
determine at least one activated set of child beams of at least one activated child PRS resource set configuration based on the one or more measurements; and
perform one or more measurements associated with the at least one activated set of child beams of the at least one activated child PRS resource set configuration in accordance with at least one respective child PRS resource set configuration.

17. The UE of claim 16,
wherein the set of child PRS resource set configurations includes a plurality of child PRS resource set configurations, and
wherein each of the plurality of child PRS resource set configurations is associated with a different parent beam among the set of parent beams.

18. The UE of claim 17,
wherein a default child PRS resource set is designated via assistance data (AD), and
wherein the at least one activated child PRS resource set configuration corresponds to the default child PRS resource set or is modified from the default child PRS resource set configuration based on the one or more measurements of the set of parent beams.

19. The UE of claim 16,
wherein the set of child PRS resource set configurations includes a single child PRS resource set configuration, and
wherein the single child PRS resource set configuration includes the respective set of child beams for each of the set of parent beams.

20. The UE of claim 19, wherein the one or more processors, either alone or in combination, are further configured to:
determine, for each parent beam among the set of parent beams, an association between its respective set of child beams.

21. The UE of claim 20, wherein the association comprises a beamwidth threshold, a boresight direction threshold, or a combination thereof.

22. The UE of claim 16,
wherein the at least one activated set of child beams includes a single activated set of child beams associated with a best parent beam in terms of one or more performance metrics based on the one or more measurements associated with the set of parent beams, or
wherein the at least one activated set of child beams includes multiple activated sets of child beams associated with N best parent beams in terms of one or more performance metrics based on the one or more measurements associated with the set of parent beams, or
wherein the one or more measurements associated with the set of parent beams and the one or more measurements associated with the at least one activated set of child beams are performed during the same measurement period, or
wherein the set of parent beams and the at least one activated set of child beams are associated with the same frequency layer, or
wherein the set of parent beams is associated with a first frequency layer of a bandwidth of a frequency range and the at least one activated set of child beams is associated with a second frequency layer of the bandwidth of the frequency range, or
wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range, or
wherein a given child beam is included in respective sets of child beams for two or more respective parent beams, or
wherein each child beam is associated with a narrower beamwidth than its respective parent beam.

23. The UE of claim 16, wherein the one or more processors, either alone or in combination, are further configured to:
transmit, via the one or more transceivers, to the position estimation entity, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

24. The UE of claim 16,
wherein the set of parent beams is transmitted by the TRP at a first periodicity, and
wherein one or more of the sets of child beams are transmitted by the TRP at a second periodicity that is shorter than the first periodicity.

25. A position estimation entity, comprising:
one or more memories;
one or more transceivers; and
one or more processors communicatively coupled to the one or more memories and the one or more transceivers, the one or more processors, either alone or in combination, configured to:
transmit, via the one or more transceivers, to a user equipment (UE), a parent positioning reference signal (PRS) resource set configuration associated with a set of parent beams from a transmission reception point (TRP);
transmit, via the one or more transceivers, to the UE, a set of child PRS resource set configurations associated with a respective set of child beams for each of the set of parent beams, each set of child beams including one or more child beams for a respective parent beam that are each narrower than a beamwidth of the respective parent beam; and
receive, via the one or more transceivers, from the UE, at least one measurement report based on one or more measurements associated with the set of parent beams in accordance with the parent PRS resource set configuration, and one or more measurements associated with at least one activated set of child beams of at least one activated child PRS resource set configuration.

26. The position estimation entity of claim 25,
wherein the set of child PRS resource set configurations includes a plurality of child PRS resource set configurations, and each of the plurality of child PRS resource set configurations is associated with a different parent beam among the set of parent beams, or
wherein the set of child PRS resource set configurations includes a single child PRS resource set configuration, and the single child PRS resource set configuration includes the respective set of child beams for each of the set of parent beams, or
wherein the at least one activated set of child beams includes a single set of child beams associated with a best parent beam in terms of one or more performance metrics based on the one or more measurements associated with the set of parent beams.

27. The position estimation entity of claim 25,
wherein the at least one activated set of child beams includes multiple activated sets of child beams associated with N best parent beams in terms of one or more performance metrics based on the one or more measurements of the set of parent beams, or
wherein the one or more measurements associated with the set of parent beams and the one or more measurements associated with the at least one activated set of child beams are performed during the same measurement period, or
wherein the set of parent beams and the at least one activated set of child beams are associated with the same frequency layer, or
wherein the set of parent beams is associated with a first frequency layer of a bandwidth of a frequency range and the at least one activated set of child beams is associated with a second frequency layer of the bandwidth of the frequency range, or
wherein the set of parent beams is associated with a third frequency layer of a first bandwidth of a first frequency range and the at least one activated set of child beams is associated with a fourth frequency layer of a second bandwidth of a second frequency range that is within a bandwidth threshold of the first bandwidth of the first frequency range.

28. The position estimation entity of claim 25, wherein the one or more processors, either alone or in combination, are further configured to:
receive, via the one or more transceivers, from the UE, an indication of a capability of the UE to support a parent-to-child beam association between parent and child beams within the same frequency layer, within different frequency layers in the same bandwidth of a frequency range, within different frequency layers of different bandwidths of different frequency ranges, or a combination thereof.

29. The position estimation entity of claim 25, wherein each child beam is associated with a narrower beamwidth than its respective parent beam.

30. The position estimation entity of claim 25, wherein the at least one measurement report comprises multiple measurement reports.
